(19) United States
(12) Patent Application Publication
(10) Pub. No.: US 2025/0183483 A1
(43) Pub. Date: Jun. 5, 2025

(54) METHOD OF MANUFACTURING LAMINATE FOR BATTERY, APPARATUS FOR MANUFACTURING LAMINATE FOR BATTERY, METHOD OF MANUFACTURING MEMBER FOR BATTERY, AND APPARATUS FOR MANUFACTURING MEMBER FOR BATTERY

(71) Applicants: Keigo TAKAUJI, Kanagawa (JP); Miku OHKIMOTO, Kanagawa (JP); Manabu ARITA, Tokyo (JP); Nozomi TERAI, Saitama (JP); Daisuke NOSE, Kanagawa (JP); Naoki SUGIHARA, Kanagawa (JP); Takuya YAMAZAKI, Kanagawa (JP); Sayaka KAI, Kanagawa (JP); Hiromichi KURIYAMA, Kanagawa (JP); Naoto ABE, Shizuoka (JP)

(72) Inventors: Keigo TAKAUJI, Kanagawa (JP); Miku OHKIMOTO, Kanagawa (JP); Manabu ARITA, Tokyo (JP); Nozomi TERAI, Saitama (JP); Daisuke NOSE, Kanagawa (JP); Naoki SUGIHARA, Kanagawa (JP); Takuya YAMAZAKI, Kanagawa (JP); Sayaka KAI, Kanagawa (JP); Hiromichi KURIYAMA, Kanagawa (JP); Naoto ABE, Shizuoka (JP)

(21) Appl. No.: 18/843,704

(22) PCT Filed: Mar. 16, 2023
(86) PCT No.: PCT/IB2023/052550

§ 371 Date: Sep. 4, 2024

(30) Foreign Application Priority Data
Mar. 17, 2022 (JP) 2022-043142
Mar. 17, 2022 (JP) 2022-043144

(51) Int. Cl. H01M 50/46; H01M 4/04; H01M 4/139; H01M 50/406; H01M 50/463

(52) U.S. Cl. CPC H01M 50/46; H01M 4/0404; H01M 4/139; H01M 50/406; H01M 50/463; H01M 4/0435

(57) ABSTRACT

A method of manufacturing a laminate for a battery is provided that includes forming an insulating layer by applying a liquid composition onto a first electrode, and placing a second electrode on the first electrode formed with the insulating layer. The forming and the placing are implemented by a conveyance series.

### TECHNICAL FIELD

The present disclosure relates to a method of manufacturing a laminate for a battery, an apparatus for manufacturing a laminate for a battery, a method of manufacturing a member for a battery, and an apparatus for manufacturing a member for a battery.

### BACKGROUND ART

In recent years, there has been a rapid increase in demand for power storage elements such as batteries and power generation elements such as fuel cells having higher output, higher capacity, and a longer service life. However, to meet this demand, there are still various issues related to the safety of such elements. For example, a short circuit between electrodes of a battery may be caused by misalignment or breakage of an insulating layer provided between the electrodes. Such a short circuit may lead to accidents such as the battery exploding and igniting, and thus, further improvement is desired.

Under these circumstances, an insulating layer that is integrally formed with an electrode has been proposed as described in PTL 1.

### CITATION LIST

### Patent Literature

[PTL 1]
Japanese Unexamined Patent Application Publication No. 2013-191550
[PTL 2]
Japanese Unexamined Patent Application Publication No. 2012-33282

### SUMMARY OF INVENTION

### Technical Problem

However, in the insulating layer that is integrally formed with an electrode, there is room for improvement in that, if the electrode, which forms a base, has low strength, the insulating layer is easily damaged by cracks or the like originating when the electrode, which forms the base, is deformed upon receiving an impact by bending or the like during an electrode manufacturing process.

### Solution to Problem

Embodiments of the present invention provide a method of manufacturing a laminate for a battery that includes forming an insulating layer by applying a liquid composition onto a first electrode, and placing a second electrode on the first electrode formed with the insulating layer, and the forming and the placing are implemented by a conveyance series.

### Advantageous Effects of Invention

According to the technology disclosed herein, it is possible to prevent a laminate for a battery from breaking in a process of manufacturing an electrode.

### BRIEF DESCRIPTION OF DRAWINGS

A more complete appreciation of embodiments of the present disclosure and many of the attendant advantages and features thereof can be readily obtained and understood from the following detailed description with reference to the accompanying drawings.

FIG. 1 is a (first) diagram illustrating an apparatus for manufacturing a laminate for a battery according to an embodiment.

FIG. 2 is a (second) diagram illustrating an apparatus for manufacturing a laminate for a battery according to an embodiment.

FIG. 3 is a (third) diagram illustrating an apparatus for manufacturing a laminate for a battery according to an embodiment.

FIG. 4 is a (fourth) diagram illustrating an apparatus for manufacturing a laminate for a battery according to an embodiment.

FIG. 5 is a (fifth) diagram illustrating an apparatus for manufacturing a laminate for a battery according to an embodiment.

FIG. 6 is a (sixth) diagram illustrating an apparatus for manufacturing a laminate for a battery according to an embodiment.

FIG. 7 is a (seventh) diagram illustrating an apparatus for manufacturing a laminate for a battery according to an embodiment.

FIG. 8 is an example of a block diagram of main hardware of a control unit.

FIG. 9 is an example of a diagram of main functional blocks of the control unit.

FIG. 10 includes a plan view and a cross-sectional view illustrating a first electrode on which an insulating layer is formed.

FIG. 11 is a plan view illustrating the first electrode on which the insulating layer is formed.

FIG. 12 is a (first) plan view illustrating a state where a second electrode is placed on the first electrode on which the insulating layer is formed.

FIG. 13 is a (second) plan view illustrating a state where the second electrode is placed on the first electrode on which the insulating layer is formed.

FIG. 14 is a cross-sectional view illustrating the laminate for a battery.

FIG. 15 is a table summarizing examples and comparative examples.

FIG. 16 is a (first) diagram illustrating an apparatus for manufacturing a member for a battery according to an embodiment.

FIG. 17 is a (second) diagram illustrating an apparatus for manufacturing a member for a battery according to an embodiment.

FIG. 18 is a (third) diagram illustrating an apparatus for manufacturing a member for a battery according to an embodiment.

FIG. 19 is a (fourth) diagram illustrating an apparatus for manufacturing a member for a battery according to an embodiment.

FIG. 20 is a (fifth) diagram illustrating an apparatus for manufacturing a member for a battery according to an embodiment.

FIG. 21 is a (sixth) diagram illustrating an apparatus for manufacturing a member for a battery according to an embodiment.

FIG. 22 is a (seventh) diagram illustrating an apparatus for manufacturing a member for a battery according to an embodiment.

FIG. 23 is an example of a block diagram of main hardware of a control unit.

FIG. 24 is an example of a diagram of main functional blocks of the control unit.

FIGS. 25A and 25B illustrate a change in a conveyance speed of a conveyance unit.

FIG. 26 includes a plan view and a cross-sectional view illustrating a first base on which an insulating layer is formed.

FIG. 27 is a plan view illustrating the first base on which the insulating layer is formed.

FIG. 28 is a (first) plan view illustrating a state where a second base is placed on the first base on which the insulating layer is formed.

FIG. 29 is a (second) plan view illustrating a state where the second base is placed on the first base on which the insulating layer is formed.

FIG. 30 is a cross-sectional view illustrating a member for a battery.

FIG. 31 is a table summarizing examples and comparative examples.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below.

As used herein, the singular forms “a,” “an,” and “the” are intended to include the plural forms as well, unless the context clearly indicates otherwise.

Embodiments for implementing the present disclosure will be described below with reference to the drawings. In each drawing, the same constituent components are denoted by the same reference numerals, and redundant explanation may be omitted.

A battery to which the present embodiment can be applied is not particularly limited. In general, the present embodiment can be preferably applied to a secondary battery, a capacitor, and especially a lithium ion secondary battery, which are power storage elements. Further, a laminate for a battery according to the present embodiments has a structure in which a negative electrode and a positive electrode are laminated with an insulating layer interposed therebetween, and the negative electrode and the positive electrode are insulated from each other by the insulating layer. A battery is formed from the laminate for a battery, an electrolyte solution injected into the laminate for a battery, an outer package for sealing the laminate for a battery and the electrolyte solution, and the like.

### <Electrode (First Electrode, Second Electrode)>

An electrode is a general term for a negative electrode and a positive electrode which will be described below, and one of the electrodes may be referred to as a first electrode and the other one as a second electrode. That is, in a case where the first electrode is a member used as a negative electrode, the second electrode refers to a positive electrode, and in a case where the first electrode is a member used as a positive electrode, the second electrode refers to a negative electrode. A negative electrode substrate and a positive electrode substrate are collectively referred to as an electrode substrate, and a negative electrode mixture layer and a positive electrode mixture layer are collectively referred to as an electrode mixture layer.

### <<Electrode Substrate>>

The negative electrode substrate and the positive electrode substrate are not particularly limited as long as the negative electrode substrate and the positive electrode substrate are conductive substrates. General examples of the electrode substrates to be used include, but are not limited to, aluminum foil, copper foil, stainless steel foil, titanium foil, and etched foils obtained by etching these foils to form fine holes, which are suitably used for a secondary battery, a capacitor, and especially a lithium ion secondary battery, which are power storage elements; and a perforated electrode substrate having holes used for a lithium ion capacitor.

Other examples of the electrode substrates to be used include, but are not limited to, carbon paper used for a power generation element such as a fuel cell, a fibrous electrode that is formed into a non-woven or woven planar surface, and the above-described perforated electrode substrate formed with fine holes. In addition to the above, examples of electrode substrates to be used in a solar element further include, but are not limited to, a flat substrate formed of glass or plastic on which a transparent semiconductor film including indium-titanium oxide or zinc oxide is formed, and a flat substrate on which a thin conductive electrode film is deposited.

The electrode substrate may be formed by using an electrode substrate forming liquid composition.

### —Electrode Substrate Layer Forming Liquid Composition—

Examples of the material forming the electrode substrate layer include, but are not limited to, gold, silver, copper, silver-coated copper, aluminum, nickel, and cobalt.

One type of these metal oxide particles or metal particles may be selected, or a plurality of types of these materials may be mixed at any ratio.

Among these, silver oxide, copper oxide, silver, copper, and silver-coated copper, which form a sintered body of silver and/or copper by sintering, are preferable from the viewpoint of electrical conductivity.

The shape of these particles is not particularly limited, and examples of the particles include, but are not limited to, spherical, flat (plate-shaped), or amorphous particles.

The particle diameter of the metal particles or the metal oxide particles to be used depends on the desired printing accuracy. If the particle diameter is too small, it is difficult to select the ink formulation and the amount of protective colloid used to prevent aggregation increases.

On the other hand, if the particle diameter is too large, it is not possible to perform fine pattern printing and contact between the particles is poor, which makes sintering difficult.

Therefore, the particle diameter is generally selected in a range from 5 nm to 10 m, and more preferably in a range from 10 nm to 5 km.

The particle diameter as used herein refers to a particle diameter defined as the number-based average particle diameter D50 (median diameter) that can be measured by a laser diffraction/scattering method or a dynamic light scattering method.

Examples of reducing agents used in combination with the metal oxide particles include, but are not limited to, alcohol compounds such as methanol, ethanol, isopropyl alcohol, butanol, cyclohexanol, and terpeniol; polyvalent alcohols such as ethylene glycol, propylene glycol, and glycerin; carboxylic acids such as formic acid, acetic acid, oxalic acid, and succinic acid; carbonyl compounds such as acetone, methyl ethyl ketone, cyclohexane, benzaldehyde, and octylaldehyde; ester compounds such as ethyl acetate, butyl acetate, and phenyl acetate; and hydrocarbon compounds such as hexane, octane, toluene, naphthalene, and decalin.

Among these, polyvalent alcohols such as ethylene glycol, propylene glycol, and glycerin, and carboxylic acids such as formic acid, acetic acid, and oxalic acid are preferable from the viewpoint of the efficiency of the reducing agent.

To use, as ink in a printing process, a conductor pattern forming composition containing metal oxide particles and a reducing agent and/or metal particles, a binder resin may be added, and a binder resin that also serves as a reducing agent may be used.

Examples of polymer compounds that can also serve as reducing agents include, but are not limited to, thermoplastic resins and thermosetting resins including poly-N-vinyl compounds such as polyvinylpyrrolidone and polyvinylcaprolactone; polyalkylene glycol compounds such as polyethylene glycol, polypropylene glycol, and polyTHF; polyurethane; cellulose compounds and derivatives thereof; epoxy compounds; polyester compounds; chlorinated polyolefins; and polyacrylic compounds.

Among these, polyvinylpyrrolidone is preferable in consideration of a binder effect, and polyethylene glycol, polypropylene glycol, and polyurethane compounds are preferable in consideration of a reducing effect.

Polyethylene glycol and polypropylene glycol belong to the category of polyvalent alcohols, and have particularly suitable properties as reducing agents.

In an electrode substrate layer forming composition, an electrode substrate layer is formed by sintering metal particles or particles obtained by reducing metal oxides by heating using an internal heating method.

In the internal heating method, the metal particles and/or metal oxide particles in the electrode substrate layer forming composition generate heat, but the base does not generate heat.

Thus, even if a plastic base having poor heat resistance is used, deformation of the base can be prevented.

Therefore, the electrode substrate layer forming composition can be heated until the electrode substrate layer forming composition provides sufficient conductivity.

As the internal heating method, a heating method by pulsed light irradiation or microwave irradiation can be selected from the viewpoint of improving productivity, and pulsed light irradiation is more preferable.

### <Functional Layer>

A functional layer as used herein refers to a part of a member that causes a battery to exhibit a function in a storage or charging operation of the battery. For example, the functional layer is an electrode mixture layer having a function by which a positive electrode or a negative electrode develop capacity or a function of contributing to ion conduction, or an insulating layer having a function of contributing to maintaining insulation of the positive electrode or the negative electrode, or between the positive electrode and the negative electrode.

### <<Electrode Mixture Layer>>

The negative electrode mixture layer and the positive electrode mixture layer are not particularly limited and can be appropriately selected according to the purpose. For example, the negative electrode mixture layer and the positive electrode mixture layer may include at least an active material (a negative electrode active material or a positive electrode active material) and may contain, if desired, a binder (binding agent), a thickener, a conductive agent, a dispersant, a non-aqueous electrolyte solution, a solid electrolyte, a gel electrolyte, or one or more monomers that form a gel electrolyte through a polymerization process. The negative electrode mixture layer contains a negative electrode active material, and the positive electrode mixture layer contains a positive electrode active material.

### —Electrode Mixture Layer Forming Liquid Composition—

An electrode mixture layer forming liquid composition contains at least one of a positive electrode active material and a negative electrode active material.

The electrode mixture layer forming liquid composition applied by inkjet printing may further contain, if desired, a dispersion medium, a dispersant, a conductive auxiliary agent, a binder, a non-aqueous electrolyte solution, a solid electrolyte, a gel electrolyte, or one or more monomers that form a gel electrolyte through a polymerization process.

The negative electrode mixture layer and the positive electrode mixture layer can be formed by dispersing a powdery active material or a catalyst composition in a liquid, coating and fixing the resulting liquid onto an electrode substrate, fixed, and drying the obtained coated electrode substrate. Typically, the negative electrode mixture layer and the positive electrode mixture layer are formed by print coating using a spray, a dispenser, or a die coater, and drying after the coating.

The negative electrode active material is not particularly limited as long as the negative electrode active material is a material by which alkali metal ions can be occluded and released reversibly, that is, a material by which metals that are alloyed with alkali metal ions such as Li ions and Na ions can be occluded and from which the alkali metal ions can be desorbed.

Typically, carbon materials containing graphite having a graphite-type crystal structure may be used as the negative electrode active material. Examples of the carbon materials include, but are not limited to, natural graphite, spherical or fibrous synthetic graphite, non-graphitizing carbon (hard carbon), and easily graphitized carbon (soft carbon). Examples of materials other than the carbon materials include, but are not limited to, lithium titanate.

From the viewpoint of improving the energy density of lithium ion batteries, materials having high capacity such as silicon, tin, silicon alloys, tin alloys, silicon oxide, silicon nitride, and tin oxide may be suitably used as the negative electrode active material.

Examples of the active material in nickel hydrogen batteries include, but are not limited to, hydrogen occlusion alloys, specifically AB2-type or A2B-type hydrogen occlusion alloys such as Zr—Ti—Mn—Fe—Ag—V—Al—W and Ti15Zr21V15Ni29Cr5Co5Fe1Mn8.

Other examples of the active material include, but are not limited to, inorganic compounds such as composite oxides of transition metals and Li, metal oxides, alloy-type materials, and transition metal sulfides, carbon materials, organic compounds, metallic Li, and metallic Na.

Examples of the composite oxides include, but are not limited to, LiMnO₂, LiMn₂O₄, lithium titanate (Li₄Ti₅O₁₂, Li₂Ti₃O₇), lithium manganese titanate (LiMg1/2Ti3/2O4), lithium cobalt titanate (LiCo1/2Ti3/2O4), lithium zinc titanate (LiZn_{1/2}Ti_{3/2}O₄), lithium iron titanate (LiFeTiO₄), lithium chromium titanate (LiCrTiO₄), lithium strontium titanate (Li₂SrTi₆O₁₄), and lithium barium titanate (Li₂BaTi₆O₁₄).

Examples of sodium composite oxides include, but are not limited to, sodium titanates such as Na₂Ti₃O₇ or Na₄Ti₅O₁₂.

Ti or Na in the sodium titanates may be partly substituted by other elements.

Examples of such elements include, but are not limited to, one or more types selected from the group consisting of Ni, Co, Mn, Fe, Al, and Cr.

Examples of the metal oxides include, but are not limited to, TiO₂, Nb₂TiO₇, WO₃, MoO₂, MnO₂, V₂O₅, SiO₂, SiO, and SnO₂.

Examples of the alloy-type materials include, but are not limited to, Al, Si, Sn, Ge, Pb, As, and Sb.

Examples of the transition metal sulfides include, but are not limited to, FeS and TiS.

As the inorganic compound, a compound obtained by substituting a transition metal of the above-listed composite oxides with a heteroatom may be used.

Each of these negative electrode active materials may be used alone or in combination with others.

The positive electrode active material is not particularly limited as long as the positive electrode active material is a material by which alkali metal ions can be occluded and released reversibly. Typically, transition metal compounds containing alkali metals may be used as the positive electrode active material. Examples of transition metal compounds containing lithium include, but are not limited to, composite oxides containing lithium and at least one element selected from the group consisting of cobalt, manganese, nickel, chromium, iron, and vanadium.

Examples of the composite oxides include, but are not limited to, transition metal oxides containing lithium such as lithium cobalt oxide, lithium nickel oxide, and lithium manganese oxide, olivine-type lithium salts such as LiFePO₄, chalcogen compounds such as titanium disulfide and molybdenum disulfide, and manganese dioxide.

The transition metal oxides containing lithium are metal oxides containing lithium and a transition metal, or metal oxides in which transition metal atoms are partly substituted by heteroatoms. Examples of the heteroatoms include, but are not limited to, Na, Mg, Sc, Y, Mn, Fe, Co, Ni, Cu, Zn, Al, Cr, Pb, Sb, and B. Among these, Mn, Al, Co, Ni, and Mg are preferable. Examples of the transition metal compounds containing alkali metals include, but are not limited to, polyanionic compounds whose crystal structure includes an XO4 tetrahedron (X=P, S, As, Mo, W, Si, etc.).

Among these, transition metal phosphate compounds containing lithium such as lithium iron phosphate or lithium vanadium phosphate are preferable in terms of cycle characteristics.

In particular, lithium vanadium phosphate has a high lithium diffusion coefficient and excellent output characteristics.

Preferably, from the viewpoint of electron conductivity, a surface of the polyanionic compounds is coated with a conductive auxiliary agent such as a carbon material to form a composite.

Examples of transition metal compounds containing sodium include, but are not limited to, NaMO₂ type oxides, sodium chromite (NaCrO₂), sodium ferrate (NaFeO₂), sodium nickelate (NaNiO₂), sodium cobaltate (NaCoO₂), sodium manganate (NaMnO₂), and sodium vanadate (NaVO₂).

A part of M may be substituted with at least one type selected from the group consisting of metal elements other than M and Na, for example, Cr, Ni, Fe, Co, Mn, V, Ti, and Al. Examples of metal oxides containing sodium include, but are not limited to, Na₂FePO₄F, NaVPO₄F, NaCoPO₄, NaNiPO₄, NaMnPO₄, NaMn_{1.5}Ni_{0.5}O₄, and Na₂V₂(PO₄)₃.

The heteroatom may be one type, or two or more types of heteroatoms may be used. Each of these positive electrode active materials may be used alone or in combination with others.

Examples of the active material in nickel hydrogen batteries include, but are not limited to, nickel hydroxide.

Examples of the binder used in the negative electrode or the positive electrode include, but are not limited to, PVDF, PTFE, polyethylene, polypropylene, aramid resin, polyamide, polyimide, polyamideimide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinyl pyrrolidone, polyether, polyether sulfone, hexafluoropolypropylene, styrene butadiene rubber, and carboxymethyl cellulose.

Other examples of the binder include, but are not limited to, copolymers of two or more materials selected from tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. A mixture of two or more materials selected from these materials may be used.

Examples of the conducting agent contained in the electrode mixture layer include, but are not limited to, graphite such as natural graphite and synthetic graphite; carbon black such as acetylene black, Ketjen black, channel black, furnace black, lamp black, and thermal black; conductive fibers such as carbon fibers and metal fibers; carbon fluoride; powders of metals such as aluminum; conductive whiskers such as zinc oxide and potassium titanate; conductive metal oxides such as titanium oxide; and organic conductive materials such as phenylene derivatives and graphene derivatives.

Generally, the active material used in fuel cells employs, as a catalyst for the cathode electrode and the anode electrode, a catalyst carrier such as carbon in which fine metal particles such as platinum, ruthenium, and platinum alloys are supported. For example, to support the catalyst particles on a surface of the catalyst carrier, the catalyst carrier is suspended in water, and a precursor of the catalyst particles are added thereto to dissolve the precursor in the suspension, and then, an alkali is added to obtain a hydroxide of the metal. (Examples of the precursor of the catalyst particles include, but are not limited to, precursors containing alloy components such as chloroplatinic acid, dinitrodiamino platinum, platinum(IV) chloride, platinum(II) chloride, platinum bisacetylacetonato, dichlorodiammine platinum, dichlorotetramine platinum, platinum sulfate chlororuthenate, hexachloroiridate, hexachlororhodate, ferric chloride, cobalt chloride, chromium chloride, gold chloride, silver nitrate, rhodium nitrate, palladium chloride, nickel nitrate, iron sulfate, and copper chloride.) The catalyst carrier is then coated onto the electrode substrate and reduced under a hydrogen atmosphere or the like, to prepare an electrode mixture layer having a surface coated with the catalyst particles (active material).

Examples of the active material used in solar cells include, but are not limited to, tungsten oxide powder, titanium oxide powder, and semiconductor layers of oxides such as SnO₂, ZnO, ZrO₂, Nb₂O₅, CeO₂, SiO₂, and Al₂O₃. Such semiconductor layers carry a dye. Examples of the dye include, but are not limited to, compounds such as ruthenium-tris transition metal complexes, ruthenium-bis transition metal complexes, osmium-tris transition metal complexes, osmium-bis transition metal complexes, a ruthenium-cis-diaqua-bipyridyl complex, phthalocyanine, porphyrin, and organic-inorganic perovskite crystals.

The positive electrode active material may be used alone, or two or more kinds may be mixed and used.

The dispersion medium is not particularly limited as long as the active material can be dispersed therein. Examples of the dispersion medium include, but are not limited to, an aqueous dispersion medium such as water, ethylene glycol, and propylene glycol, and organic dispersion media such as N-methyl-2-pyrrolidone, 2-pyrrolidone, cyclohexanone, ethyl lactate, butyl acetate, mesitylene, ethylene glycol monoethyl ether, ethylene glycol monobutyl ether, ethylene glycol monoethyl ether acetate, diethylene glycol monoethyl ether, diethylene glycol monobutyl ether, propylene glycol monomethyl ether, propylene glycol monoethyl ether, propylene glycol monobutyl ether, dibutyl ether, diethyl ether, di-tert-butyl ether, 2-n-butoxymethanol, 2-dimethylethanol, N,N-dimethylacetamide, anisole, diethoxyethane, normal hexane, heptane, octane, nonane, decane, and p-menthane.

Each of the dispersion media may be used alone or in combination with others.

The conductive auxiliary agent may be compounded with the active material in advance, or may be added when the dispersion liquid is prepared.

Examples of the conductive auxiliary agent include, but are not limited to, conductive carbon black prepared by a furnace method, an acetylene method, or a gasification method, and carbon materials such as carbon nanofibers, carbon nanotubes, graphene, and graphite particles.

Examples of the conductive auxiliary agent other than the carbon materials include, but are not limited to, metal particles and metal fibers including aluminum.

The mass ratio of the conductive auxiliary agent with respect to the active material is preferably 10% or less, and more preferably 8% or less.

If the mass ratio of the conductive auxiliary agent with respect to the active material is 10% or less, the stability of the dispersion liquid improves.

The dispersant is not particularly limited as long as the dispersant can improve the dispersibility of the active material, the polymer particles, or the conductive auxiliary agent in the dispersion medium. Examples of the dispersant include, but are not limited to, polymer dispersants such as polycarboxylic acid dispersants, naphthalenesulfonate formalin condensate dispersants, polyethylene glycol, polycarboxylic acid partial alkyl ester dispersants, polyether dispersants, and polyalkylene polyamine dispersants, surfactant-type dispersants such as alkyl sulfonic acid dispersants, quaternary ammonium dispersants, polyvalent alcohol alkylene oxide dispersants, polyol ester dispersants, and alkylpolyamine dispersants, and inorganic dispersants such as polyphosphate dispersants.

The binder is added when the binding between the positive electrode materials or between the negative electrode materials, or the binding between the positive electrode material or the negative electrode material and the electrically conductive layer with the dispersant or the electrolyte material is not sufficient, so that a binding force can be ensured.

The binder is not particularly limited as long as the binder can impart a binding force, but from the viewpoint of inkjet discharge properties, a compound that does not increase the viscosity is preferable.

To obtain the binder, a monomer compound may be polymerized after inkjet printing, or polymer particles may be used as the binder.

An example of a material that does not increase the viscosity of the liquid composition includes, but is not limited to, a polymer compound that can be dispersed in the dispersion medium.

If a polymer compound that can be dissolved in the dispersion medium is used, a liquid composition in which the polymer compound is dissolved in the dispersion medium preferably has a viscosity at which the liquid composition can be discharged from a liquid discharge head.

Examples of using the monomer compound include, but are not limited to, a method in which a dispersion liquid containing a compound having a polymerizable site and a polymerization initiator or a catalyst, in which the compound having a polymerizable site is dissolved, is applied and the applied dispersion liquid is heated, or a method of irradiation with non-ionizing radiation, ionizing radiation, or infrared rays.

In the compound having a polymerizable site, one polymer site may be included in the molecule or the compound may be polyfunctional.

The polyfunctional polymerizable compound as used herein refers to a compound having two or more polymerizable groups.

The polyfunctional polymerizable compound is not particularly limited as long as the polyfunctional polymerizable compound can be polymerized by heating or irradiation with non-ionizing radiation, ionizing radiation, or infrared rays.

Examples of the polyfunctional polymerizable compound include, but are not limited to, an acrylate resin, a methacrylate resin, an urethane acrylate resin, a vinyl ester resin, unsaturated polyesters, epoxy resins, oxetane resins, vinyl ether, and resins obtained by a thiol-ene reaction.

Among these, the acrylate resin, the methacrylate resin, the urethane acrylate resin, and the vinyl ester resin are preferable from the viewpoint of productivity.

Examples of a material forming the polymer particles include, but are not limited to, polyvinylidene fluoride, acrylic resins, polyamide compounds, polyimide compounds, polyamideimide, ethylene-propylene-butadiene rubber (EPBR), a styrene-butadiene copolymer, nitrile-butadiene rubber (HNBR), isoprene rubber, polyisobutene, polyethylene glycol (PEO), polymethyl methacrylic acid (PMMA), polyethylene vinyl acetate (PEVA), polyethylene, polypropylene, polyurethane, nylon, polytetrafluoroethylene, polyphenylene sulfide, polyethylene terephthalate, and polybutyleneterephthalate.

Examples of the polymer compound include, but are not limited to, polyamide compounds, polyimide compounds, polyamideimide, ethylene-propylene-butadiene rubber (EPBR), styrene-butadiene rubber (SBR), nitrile-butadiene rubber (NBR), isoprene rubber, polyisobutene, polyethylene glycol (PEO), polymethyl methacrylic acid (PMMA), and polyethylene vinyl acetate (PEVA).

The mass ratio of the binder with respect to the active material is preferably 10% or less, and more preferably 5% or less.

If the mass ratio of the binder with respect to the active material is 10% or less, the binding force when forming the electrode is improved without impairing the dischargeability.

### <Insulating Layer>

The insulating layer is a member that physically separates the positive electrode and the negative electrode and ensures ion conductivity between the positive electrode and the negative electrode. The insulating layer is provided on a current collector or on the electrode mixture layer, or on both the current collector and the electrode mixture layer. The insulating layer may be provided on an insulating base such as glass, epoxy glass, polyimide (PI), polyethylene naphthalate (PEN), polyethylene terephthalate (PET), cellulose paper, and rubber. In this case, functions such as abrasion resistance and thermal adhesiveness can be imparted to the surface.

The insulating layer is not particularly limited, but is preferably a layer exhibiting a volume specific resistivity of 1×10¹² (Ω·cm) or more. If the volume specific resistivity is 1×10¹² (Q cm) or more, an electrical short circuit between the positive and negative electrodes is less likely to occur. A film thickness of the insulating layer is not particularly limited, as long as insulation between the positive electrode and the negative electrode is maintained, but is preferably 1 μm or more and 50 μm or less, and particularly preferably 5 μm or more and 20 m or less. If the film thickness is thinner than the above ranges, it is difficult to maintain good insulation between the positive electrode and the negative electrode. On the other hand, if the film thickness is greater than the above ranges, it is difficult to ensure good ionic conductivity.

The insulating layer is a porous insulating layer including pores, and the size of the pores is not particularly limited, as long as the insulating layer has ionic conductivity. However, from the viewpoint of permeability of the electrolyte solution, the size of the pores is preferably 0.01 μm or more and 10 μm or less. The porosity of the insulating layer is preferably 30% or more, and more preferably 50% or more.

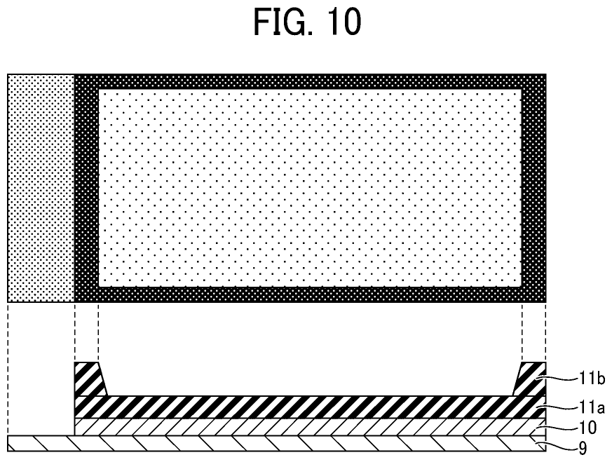

As illustrated in FIG. 10 referred to in the later description, in the insulating layer, a thick film region may be formed in a periphery of the electrode. In FIG. 10, reference numeral 9 denotes a current collector of a first electrode, reference numeral 10 denotes an active material of the first electrode, reference numeral 11a denotes a thin film region of an insulating layer, and reference numeral 11b denotes a thick film region of the insulating layer. The term “a periphery of the electrode” as used herein preferably refers to a periphery of a surface of the first electrode where an electrode mixture layer is formed. More preferably, in a state where a second electrode having a polarity different from the first electrode is laminated to form an electrode laminate, “a periphery of the electrode” is a region where the second electrode does not face a surface of the electrode mixture layer of the first electrode. By forming the thick film region, when the first electrode and the second electrode are laminated on one another, distortion of the electrodes at ends thereof can be prevented, and misalignment during lamination can be suppressed. The thick film region is formed from a material having a melting point or a glass transition temperature (Tg), so that after lamination, thick film regions of first electrodes positioned above and below in the laminates can be heat-bonded.

The insulating layer according to the present embodiment may have a configuration in which a plurality of resin structures are stacked.

### <Insulating Layer Forming Liquid Composition>

An insulating layer forming liquid composition is a liquid to be applied to form an insulating layer, and contains an organic and/or an inorganic compound, a solvent or a dispersion liquid, and the like. The above-mentioned organic and/or inorganic compound and solvent or dispersion liquid can be suitably selected, if desired, as long as the finally formed organic layer and/or inorganic layer has insulating properties.

Examples of an insulating inorganic material include, but are not limited to, metal oxides, metal nitrides, and other fine metal particles. Preferred examples of the metal oxides include, but are not limited to, Al₂O₃(alumina), TiO₂, BaTiO₃, and ZrO₂. Preferred examples of the metal nitrides include, but are not limited to, aluminum nitride and silicon nitride. Preferred examples of other fine metal particles include, but are not limited to, fine particles of ionic crystals having poor solubility such as aluminum fluoride, calcium fluoride, barium fluoride, and barium sulfate, or substances derived from mineral resources such as boehmite, zeolite, apatite, kaolin, mullite, spinel, olivine, sericite, and bentonite, and artificial products of these materials. Examples of the insulating inorganic material include, but are not limited to, glass ceramic powder. Preferred examples of the glass ceramic powder include, but are not limited to, crystallized glass ceramic using ZnO—MgO—Al₂O₃—SiO₂-based crystallized glass, and non-glass ceramic using BaO—Al₂O₃—SiO₂-based ceramic powder or Al₂O₃—CaO—SiO₂—MgO—B₂O₃-based ceramic powder.

Among these, aluminum oxide and silica are preferable, and α-alumina is more preferable, from the viewpoint of insulation and heat resistance. α-alumina can function as a scavenger for “junk” chemical species, that is, chemical species that may cause capacity fade in lithium ion secondary batteries.

In addition, ceramic solid electrolytes such as oxides and sulfides can also be utilized as a solid electrolyte. Examples of the oxides include, but are not limited to, LISICON-type oxides such as γ-Li₃PO₄, Li₃BO₄, a 0.75Li₄GeO₄-0.25Li₂ZnGeO₄ solid solution, a Li₄SiO₄—Zn₂SiO₄ solid solution, and a Li₄GeO₄—Li₃VO₄ solid solution, NASICON-type oxides such as Li_{1.3}Al_{0.3}Ti_{1.7}(PO₄)₃ and Li_{1.6}Al_{0.6}Ge_{0.8}Ti_{0.6}(PO₄)₃, and (Li, La)TiO₃ having a perovskite-type structure, and garnet-type oxides such as La₅Li₃Nb₂O₁₂, Li₅La₃TaOI₂, and Li₇La₃Zr₂O₁₂.

Examples of the sulfides include, but are not limited to, a Li₄GeS₄—Li₃PS₄ solid solution, a Li₄SiS₄—Li₃PS₄ solid solution, a Li₃PS₄—Li₂S solid solution, a Li₂S—P₂S₅ solid solution, Li₂S—SiS₂, Li₁₀GeP₂S₁₂, Argyrodite-type Li₆PS₅X (X=Cl, Br, I), and L₇P₃S₁₁ crystals.

### (Ceramic Solid Electrolyte for Sodium-Ion Secondary Battery)

Examples of the oxides include, but are not limited to, NASICON-type Na₁₊ₓZr₂SiₓP₃₋ₓO₁₂ (0≤x≤1), and β-alumina-type Na₂O—11Al₂O₃. Examples of the sulfides include, but are not limited to, Na₂S—P₂S₅, Na₃PS₄, Na₃SbS₄, Na₂S—SiS₂, and Na₂S—GeS₂. An example of selenides includes, but is not limited to, Na3PSe₄. The materials mentioned above may be used as composite electrolytes with polymers.

The particle diameter of these inorganic materials is preferably 10 μm or less, and more preferably 3 μm or less. By choosing the particle diameter within the range mentioned above, a dense porous structure can be formed, and a porous structure having excellent ion permeability without local unevenness in a porous inner portion can be obtained. The above-described inorganic material is dispersed in a liquid to prepare a liquid composition for manufacturing the inorganic layer. A liquid suitable for the inorganic material to be dispersed is selected.

A binding material is added when the inorganic material is dispersed in the liquid. The binding material has a function of adhering the fine particles of the inorganic material so that the inorganic material is held as an insulating layer. Examples of the binding material include, but are not limited to, acrylic resins, styrene-butadiene-based resins, and polyvinylidene fluoride-based resins.

When preparing an ink for manufacturing the inorganic layer, a dispersion process may be performed by a homogenizer. The homogenizer may be of a high-speed rotary shear stirring type, a high-pressure jet dispersion type, an ultrasonic dispersion type, or a medium stirring mill type.

When preparing the ink for manufacturing the inorganic layer, additives such as a dispersant and a surfactant may be used, if desired. Examples of the dispersant and the surfactant include, but are not limited to, MEGAFACE (DIC Corporation), MALIALIM (NOF CORPORATION), ESLEAM (NOF CORPORATION), SOLSPERSE (The Lubrizol Corporation), and POLYFLOW (Kyoeisha Chemical Co., Ltd.). Examples of other additives include, but are not limited to, a thickener for adjusting viscosity such as propylene glycol and carboxymethyl cellulose.

A resin can be used as the insulating organic and/or inorganic material. To form the resin, a liquid composition for manufacturing a resin layer is used in which at least one of a resin and a precursor of the resin (the resin and/or the precursor of the resin) is dissolved or dispersed in a liquid.

A liquid is selected that is suitable for the resin to be dissolved or dispersed. Specifically, water, hydrocarbon-based liquids, alcohol-based liquids, ketone-based liquids, ester-based liquids, and ether-based liquids can be used.

Preferred examples of the resin and the precursor of the resin include, but are not limited to, a compositions in which resins or oligomers having a crosslinkable structure obtained by ionizing radiation or infrared rays (heat) in the molecule are dissolved in a liquid. Preferred examples of the resin and the precursor of the resin include, but are not limited to, low-molecular-weight oligomer precursors of polyimide resins, polyester resins, polyamide resins, polyolefin resins, and acrylic resins, and resins and precursors partially modified with hydrocarbon groups having aliphatic unsaturated bonds, for example. Resins and precursors of acrylic copolymers having an unsaturated bond in a part of side chains are preferable.

Examples of such unsaturated bonds include, but are not limited to, an allyl group, an allyloxy group, an acryloyl group, a butenyl group, a cinnamyl group, a cinnamoyl group, a crotonoyl group, a cyclohexadienyl group, an isopropenyl group, a methacryloyl group, a pentenyl group, a propenyl group, a styryl group, a vinyl group, and a butadienyl group.

By using a dispersion precursor or cellulose nanofiber having a relatively small molecular weight of 10 000 or less and heating the dispersion precursor or the cellulose nanofiber with ionizing radiation or infrared rays, the insolubility and crosslinkability after fixing can also be enhanced for polybutylene terephthalate, polyethylene terephthalate, polyacrylonitrile, polyvinylidene fluoride, polyetherketones, polyethylene naphthalate, polysulfones, polyimide, polyester, polypropylene, polyoxymethylene, polyamide, polyvinylpyrrolidone, and cellulose.

Each of these precursors may contain an azide compound of 30 parts by weight or less to enhance the crosslinkability. Examples of the azide compound include, but are not limited to, 3,3′-dichloro-4,4′-diazidodiphenylmethane, 4,4′-diazidodiphenyl ether, 4,4′-diazidodiphenyl disulfide, 4,4′-diazidodiphenylsulfide, 4,4′-diazidodiphenylsulfone, 4-azidochalcone, 4-azido-4′-hydroxychalcone, 4-azido-4′-methoxychalcone, 4-azido-4′-morpholinochalcone, 4-dimethylamino-4′-azidochalcone, 2,6-bis(4′-azidobenzal)-4-methylcyclohexanone, 2,6-bis(4′-azidobenzal)-cyclohexanone, cinnamylidene-4-azidoacetophenone, 4-azidocinnamylideneacetophenone, 4-azido-4′-dimethylaminocinnamylideneacetophenone, cinnamylidene-4-azidocinnamylideneacetone, 2,6-bis(4′-azidocinnamylidene)-4-methylcyclohexanone, 2,6-bis(4′-azidocinnamylidene)-cyclohexanone, 1,4′-azidobenzylideneindene, 1,4′-azidobenzylideneindene, 1,4′-azidobenzylidene-3-α-hydroxy-4″-azidobenzylindene, 9,4′-azidobenzylidenefluorene, 9,4′-azidocinnamylidenefluorene, 4,4′-diazidostilbene-2,2′-disulfonyl-N-(p-methoxyphenyl)amide, 4,4′-diazidostilbene-2,2′-disulfonyl-N-(p-hydroxyethylphenyl)amide, 4,4′-diazidostilbene-2,2′-disulfonyl-N-(p-hydroxyphenyl)amide, 4,4′-diazidostilbene-2,2′-disulfonylamide, 4,4′-diazidobenzophenone, 4,4′-diazidostilbene, 4,4′-diazidochalcone, 4,4′-diazidobenzalacetone, 6-azido-2-(4′-azidostyryl)benzimidazole, 3-azidobenzylideneaniline-N-oxy p-(4-azidobenzylideneamido)benzoic acid, 1,4-bis(3′-azidostyryl)benzene, 3,3′-diazidodiphenylsulfone, and 4,4′-diazidodiphenylmethane.

In particular, among these, 2,6-bis-(4′azidobenzal)-4-methylcyclohexanone and the like can be suitably used. Solvents in which these materials are dissolved are not particularly defined. However, solvents in which the above-mentioned compounds can be dissolved and whose boiling point and surface tension are suitable for subsequent coating and drying steps may be used alone or may be mixed and adjusted to be used. A resin layer that is formed of a resin and includes voids inside is preferable, because the voids substantially allow for passing of ions such as electrolytes and make it possible to impart a function as a separator and a function to prevent thermal runaway.

From the viewpoint of electrolyte permeability and liquid retention, a resin layer having ion permeability and fine openings is desirable. It is more desirable to realize ion permeability by openings or pores formed by coating and then heating a resin containing a material such as a foaming agent, or coating a resin containing a soluble salt such as an electrolyte and then immersing the coated resin in an electrolyte solution to dissolve the salt. Alternatively, ion permeability may similarly be realized by using a block-shaped molecular skeleton to obtain a specific phase separation or microphase separation after coating to form fine openings.

Alternatively, fine network openings may be obtained by adding a volatile solvent to the ink composition to cause solid-liquid phase separation in the polymerization subsequent to printing, and then, removing (drying) the solvent. In particular, a liquid composition that causes solid-liquid phase separation by polymerization (hereinafter also referred to as “polymerization-induced phase separation”) is preferable because a porous resin structure having high ion permeability can be obtained in a short time.

As for the shape of the porous insulating layer, from the viewpoint of ensuring good liquid and gas permeability, the porous insulating layer preferably has a structure in which a three-dimensional branched network structure of a cured resin or an inorganic solid forms a skeleton, and in which the plurality of pores of the porous insulating layer are continuously coupled. That is, preferably, the porous insulating layer includes multiple pores and each one of the pores is coupled to surrounding pores to assure communication between pores and the pores are spread three-dimensionally. The pores communicate with each other, which makes it easier for liquid or gas to permeate.

Whether the pores communicate with each other can be confirmed by observing a cross-sectional image of a porous structure body by a scanning electron microscope (SEM) or the like to confirm whether the pores are continuously connected to each other. One of the physical properties obtained when the pores communicate with each other is air permeability.

The air permeability of the porous structure body can be measured according to JIS P8117, for example. The air permeability is preferably 1000 seconds/100 mL or less, more preferably 500 seconds/100 mL or less, and still more preferably 300 seconds/100 mL or less. In this case, the air permeability can be measured using a Gurley densometer (product of Toyo Seiki Seisaku-sho, Ltd.), for example. For example, if the air permeability is 1000 seconds/100 mL or less, it may be determined that the pores communicate with each other.

The cross-sectional shape of the pores is not particularly limited. Examples of the cross-sectional shape include, but are not limited to, a substantially circular shape, a substantially elliptical shape, and a substantially polygonal shape. The size of the pores is also not particularly limited. The size of the pores as used herein refers to a length of the longest straight line that can be drawn in the cross-sectional shape of the pore. The size of the pores can be determined from a cross-sectional image captured by a scanning electron microscope (SEM). The size of the pores included in the porous structure body is preferably 0.1 μm or more and 10 μm or less, and more preferably 0.1 μm or more and 1 μm or less. If the size of the pores is 0.1 μm or more and 10 μm or less, the porous structure body enables liquids or gases to sufficiently permeate, which makes it possible to efficiently realize functions such as substance separation and reaction fields.

As will be described later, in a case where the porous structure body having a pore size of 10 μm or less is used as an insulating layer of a power storage element, it is possible to prevent the occurrence of a short circuit between the positive electrode and the negative electrode due to lithium dendrite generated inside the power storage element, and thus, the safety is improved. The porosity of the porous structure body is preferably 30% or more, and more preferably 50% or more.

The porosity of the porous structure body is preferably 90% or less, and more preferably 85% or less. If the porosity is 30% or more, the porous structure body enables liquids or gases to sufficiently permeate, which makes it possible to efficiently realize functions such as substance separation and reaction fields. If the porous structure body is used as an insulating layer in a power storage element, the permeability of electrolyte solutions and the transmission of ions is improved, and reactions in the power storage element are efficiently promoted.

If the porosity is 90% or less, the strength of the porous structure body is improved. A method for measuring the porosity of the porous structure body is not particularly limited.

Examples of such a method include, but are not limited to, a method for measuring the porosity by filling the porous structure with an unsaturated fatty acid (commercially available butter) and performing staining with osmium, and then, cutting out a cross-sectional structure of an inner portion by using an FIB, and measuring the porosity by using SEM.

The porous insulating layer formed of a resin is a porous resin structure body having a skeleton portion formed from the resin and hole portions where the skeleton portion is not formed. The resin structure body preferably has a co-continuous structure or a monolithic structure in which a resin part and hole parts are each continuous.

A continuous resin part means a configuration in which no interface exists in the resin part. That is, the continuous resin part is distinguished from a structure in which a plurality of resin particles are bound and coupled by a binder or the like which is a resin different from the resin particles. Such a structure can be formed, for example, by the polymerization-induced phase separation methods described above and below.

The resin may contain a resin as a gel electrolyte and a non-aqueous electrolyte solution, an ionic liquid, glyme, or an electrolyte salt.

### —Polymerizable Compound—

The polymerizable compound polymerizes to form a resin. The polymerizable compound forms a porous resin by polymerizing in a liquid composition that causes polymerization-induced phase separation. The resin formed from the polymerizable compound is preferably a resin having a network structure formed by application of active energy rays (e.g., irradiation with light and application of heat). Preferred examples of the resin include, but are not limited to, acrylate resins, methacrylate resins, urethane acrylate resins, vinyl ester resins, unsaturated polyester resins, epoxy resins, oxetane resins, vinyl ether resins, and resins formed by a thiol-ene reaction. A structure body is easily formed by utilizing radical polymerization in which the reactivity is high, and thus, from the viewpoint of productivity, it is more preferable to use acrylate resins, methacrylate resins, and urethane acrylate resins, which are formed from a polymerizable compound having a (meth)acryloyl group, and vinyl ester resins, which are formed from a polymerizable compound having a vinyl group. Each of these may be used alone or in combination with others. In a case where two or more resins are used in combination, the combination of the polymerizable compounds is not particularly limited and can be appropriately selected according to the purpose. Preferred combination examples include, but are not limited to, combinations of urethane acrylate resins as main component with other resins, for the purpose of imparting flexibility. In the present embodiment, a polymerizable compound having an acryloyl group or a methacryloyl group is referred to as a polymerizable compound having a (meth)acryloyl group.

Preferably, the polymerizable compound includes at least one radical-polymerizable functional group. Examples of such a polymerizable compound include, but are not limited to, monofunctional, difunctional, and trifunctional or higher radical-polymerizable compounds, functional monomers, and radical-polymerizable oligomers. Among these, difunctional or higher radical-polymerizable compounds are preferable.

Examples of the monofunctional radical-polymerizable compounds include, but are not limited to, 2-(2-ethoxyethoxy)ethyl acrylate, methoxypolyethylene glycol monoacrylate, methoxypolyethylene glycol monomethacrylate, phenoxypolyethylene glycol acrylate, 2-acryloyloxyethyl succinate, 2-ethylhexyl acrylate, 2-hydroxyethyl acrylate, 2-hydroxypropyl acrylate, tetrahydrofurfuryl acrylate, 2-ethylhexylcarbitol acrylate, 3-methoxybutyl acrylate, benzyl acrylate, cyclohexyl acrylate, isoamyl acrylate, isobutyl acrylate, methoxytriethylene glycol acrylate, phenoxytetraethylene glycol acrylate, cetyl acrylate, isostearyl acrylate, stearyl acrylate, and styrene monomer. Each of these may be used alone or in combination with others.

Examples of the difunctional radical-polymerizable compounds include, but are not limited to, 1,3-butanediol diacrylate, 1,4-butanediol diacrylate, 1,4-butanediol dimethacrylate, 1,6-hexanediol diacrylate, 1,6-hexanediol dimethacrylate, diethylene glycol diacrylate, polyethylene glycol diacrylate, neopentyl glycol diacrylate, EO-modified bisphenol A diacrylate, EO-modified bisphenol F diacrylate, neopentyl glycol diacrylate, and tricyclodecane dimethanol diacrylate. Each of these may be used alone or in combination with others.

Examples of the trifunctional or higher radical-polymerizable compounds include, but are not limited to, trimethylolpropane triacrylate (TMPTA), trimethylolpropane trimethacrylate, EO-modified trimethylolpropane triacrylate, PO-modified trimethylolpropane triacrylate, caprolactone-modified trimethylolpropane triacrylate, HPA-modified trimethylolpropane trimethacrylate, pentaerythritol triacrylate, pentaerythritol tetraacrylate (PETTA), glycerol triacrylate, ECH-modified glycerol triacrylate, EO-modified glycerol triacrylate, PO-modified glycerol triacrylate, tris(acryloxyethyl) isocyanurate, dipentaerythritol hexaacrylate (DPHA), caprolactone-modified dipentaerythritol hexaacrylate, dipentaerythritol hydroxypentaacrylate, alkyl-modified dipentaerythritol pentaacrylate, alkyl-modified dipentaerythritol tetraacrylate, alkyl-modified dipentaerythritol triacrylate, dimethylolpropane tetraacrylate (DTMPTA), pentaerythritol ethoxytetraacrylate, EO-modified phosphoric triacrylate, and 2,2,5,5-tetrahydroxymethylcyclopentanone tetraacrylate. Each of these may be used alone or in combination with others.

The content of the polymerizable compound in the liquid composition that causes polymerization-induced phase separation is preferably 5.0 mass % or more and 70.0 mass % or less, more preferably 10.0 mass % or more and 50.0 mass % or less, and still more preferably 20.0 mass % or more and 40.0 mass % or less, with respect to the total amount of the liquid composition. It is preferable that the content of the polymerizable compound is 70.0 mass % or less, because the pore size of the obtained porous resin is several nanometers or less, which is not too small, and the porous resin has an appropriate porosity, and thus, it is possible to avoid poor permeation of liquids and gases. It is preferable that the content of the polymerizable compound is 5.0 mass % or more, because a three-dimensional network structure is sufficiently formed in the resin to sufficiently obtain a porous structure, and the strength of the obtained porous structure is also improved.

### —Porogen—

Solvents (also referred to as “porogens” in the following description) used to cause polymerization-induced phase separation are liquids that are compatible with polymerizable compounds. Porogens are liquids that are incompatible (cause phase separation) with a polymer (resin) generated in a process of polymerizing a polymerizable compound in a liquid composition. In a case where a solvent is contained in the liquid composition, if the polymerizable compound is polymerized in the liquid composition, in other words, if the polymerizable compound is sequentially irradiated with first active energy rays and second active energy rays in the liquid composition, the polymerizable compound forms a porous resin. It is preferable that the solvent can dissolve a compound (a polymerization initiator described later) that generates a radical or an acid by light or heat. The solvent may be used alone or in combination with others. The porogen is not polymerizable.

The boiling point of one type of porogen alone or the boiling point of a combination of two or more types of porogens is preferably 50° C. or higher and 250° C. or lower, and more preferably 70° C. or higher and 200° C. or lower at normal pressure. If the boiling point is 50° C. or higher, vaporization of the porogen at about room temperature is suppressed, so that handling of the liquid composition is easy, and the content of porogen in the liquid composition can be easily controlled. If the boiling point is 250° C. or lower, the time for drying the porogen after polymerization is shortened, and the productivity of the porous resin is improved. In addition, the amount of porogen remaining inside the porous resin can be reduced, so that the quality of the porous resin is improved when the porous resin is utilized as a functional layer, such as a substance separation layer for separating substances and a reaction layer such as a reaction field, is improved.

The boiling point of one type of porogen alone or the boiling point of a combination of two or more types of porogens is preferably 120° C. or higher at normal pressure.

Examples of the porogen include, but are not limited to, ethylene glycols such as diethylene glycol monomethyl ether, ethylene glycol monobutyl ether, ethylene glycol monoisopropyl ether, and dipropylene glycol monomethyl ether; esters such as γ-butyrolactone and propylene carbonate; and amides such as N,N-dimethylacetamide. Other examples of the porogen include, but are not limited to, liquids having a relatively large molecular weight such as methyl tetradecanoate, methyl decanoate, methyl myristate, and tetradecane. Still other examples of the porogen include, but are not limited to, liquids such as acetone, 2-ethylhexanol, and 1-bromonaphthalene.

Note that the above-listed liquids may not correspond to porogens. As described above, a porogen is a liquid that is compatible with the polymerizable compound and is incompatible (causes phase separation) with the polymer (resin) generated in the process of polymerizing the polymerizable compound in the liquid composition. In other words, whether a liquid corresponds to a porogen depends on a relation between the polymerizable compound and the polymer (the resin formed by polymerization of the polymerizable compound).

The liquid composition desirably contains at least one type of porogen having the above-described specific relation with the polymerizable compound. Therefore, the range of materials selected for preparing the liquid composition is widened, and design of the liquid composition is easy. As the range of materials selected for preparing the liquid composition is widened, the liquid composition can provide a wide range of applications in response to requirements for any characteristics in addition to forming a porous structure.

For example, in a case where the liquid composition is to be discharged by inkjet, the liquid composition desirably has discharge stability and the like as a desirable characteristic in addition to the capability of forming a porous structure. In this case, the range of materials to be selected is wide, and thus, it is easy to design such a liquid composition.

As described above, the liquid composition desirably contains at least one type of porogen having the above-described specific relation with the polymerizable compound. Therefore, the liquid composition may further additionally contain a liquid (a liquid other than a porogen) that does not have the above-described specific relation with the polymerizable compound. The content of the liquid (the liquid other than the porogen) that does not have the above-described specific relation with the polymerizable compound is preferably 10.0 mass % or less, more preferably 5.0 mass % or less, and still more preferably 1.0 mass % or less with respect to the total amount of the liquid composition, and particularly preferably, the liquid composition does not contain the liquid that does not have the above-described specific relation with the polymerizable compound.

The content of the porogen in the liquid composition is preferably 30.0 mass % or more and 95.0 mass % or less, more preferably 50.0 mass % or more and 90.0 mass % or less, and still more preferably 60.0 mass % or more and 80.0 mass % or less with respect to the total amount of the liquid composition. It is preferable that the content of the porogen is 30.0 mass % or more, because the pore size of the obtained porous body is several nanometers or less, which is not too small, and the porous body has an appropriate porosity, and thus, it is possible to avoid poor permeation of liquids and gases. It is preferable that the content of the porogen is 95.0 mass % or less, because a three-dimensional network structure is sufficiently formed in the resin to sufficiently obtain a porous structure, and the strength of the obtained porous structure is also improved.

The mass ratio between the content of the polymerizable compound and the content of the porogen (polymerizable compound:porogen) in the liquid composition is preferably from 1.0:0.4 to 1.0:19.0, both inclusive, more preferably from 1.0:1.0 to 1.0:9.0, both inclusive, and still more preferably from 1.0:1.5 to 1.0:4.0, both inclusive.

### —Polymerization-Induced Phase Separation—

The porous resin can be formed by polymerization-induced phase separation. In the polymerization-induced phase separation, the porogen is compatible with the polymerizable compound, but the porogen is incompatible (phase-separated) with the polymer (the resin) generated in the process of polymerizing the polymerizable compound. There are other methods for obtaining a porous resin by phase separation, but by using the polymerization-induced phase separation method, it is possible to form a porous body having a network structure, so that a porous body having high resistance to chemicals and heat can be expected.

Further advantageously, as compared with other methods, the process time is shorter and the surface modification is easier.

Next, a process for forming a porous resin by using polymerization-induced phase separation will be described. The polymerizable compound undergoes a polymerization reaction by irradiation with light or the like to form a resin. During this process, the solubility with respect to the porogen in the growing resin decreases, which causes phase separation between the resin and the porogen. Finally, the resin forms a porous structure in which the pores are filled with the porogen and the like.

The porogen and the like is removed by drying, and a porous resin remains. Therefore, to form a porous resin having an appropriate porosity, the compatibility between the porogen and the polymerizable compound and the compatibility between the porogen and the resin formed by polymerizing the polymerizable compound are examined.

The compatibility between the porogen and the polymerizable compound is determined as follows.

First, the liquid composition is injected into a quartz cell, and the transmittance of light (visible light) of the liquid composition at a wavelength of 550 nm is measured while stirring the liquid composition using a stirrer at 300 rpm. In the present embodiment, if the light transmittance is 30% or more, the polymerizable compound and the porogen are determined to be in a compatible state, and if the light transmittance is less than 30%, the polymerizable compound and the porogen are determined to be in an incompatible state. Various conditions for measuring the light transmittance are as described below.
Quartz cell: Special microcell with screw cap (trade name: M25-UV-2)
Transmittance measurement device: USB4000, manufactured by Ocean Optics, Inc.
Stirring speed: 300 rpm
Measurement wavelength: 550 nm
Reference: Light transmittance at a wavelength of 550 nm, measured and acquired when the quartz cell filled with the air (transmittance of 100%)

The compatibility between the porogen and the resin formed by polymerizing the polymerizable compound is determined as follows.

First, fine resin particles are uniformly dispersed on a non-alkali glass substrate by spin coating to form a gap agent. Subsequently, the substrate onto which the gap agent is coated and a non-alkali glass substrate onto which the gap agent is not coated are attached to each other so as to sandwich a surface coated with the gap agent. Next, the liquid composition is filled into a space between the bonded substrates by utilizing capillary action, to prepare a “pre-UV irradiation haze measuring element”. Subsequently, the pre-UV irradiation haze measuring element is irradiated with UV light to cure the liquid composition. Finally, a periphery of the substrates is sealed with a sealing agent to prepare a “haze measuring element”. Various preparation conditions are described below.
Non-alkali glass substrate: OA-10G, manufactured by Nippon Electric Glass Co., Ltd., 40 mm, t=0.7 mm
Gap agent: Fine resin particles MICROPEARL GS-L100, average particle diameter of 100 μm, manufactured by Sekisui Chemical Co., Ltd.
Spin coating conditions: dropping amount of dispersion liquid of 150 μL, rotation speed of 1000 rpm, rotation time of 30 s
Amount of liquid composition being filled: 160 L
UV irradiation conditions: UV-LED used as light source, light source wavelength of 365 nm, irradiation intensity of 30 mW/cm2, irradiation time of 20 s
Sealing agent: TB3035B (manufactured by ThreeBond Co., Ltd.)

Next, the manufactured pre-UV irradiation haze measuring element and the haze measuring element are used to measure a haze value. The measured value of the pre-UV irradiation haze measuring element is set as a reference (a haze value of 0) and a rate of increase of a measured value (haze value) of the haze measuring element with respect to the measured value of the pre-UV irradiation haze measuring element is calculated. The haze value of the haze measuring element increases as the compatibility between the porogen and the resin formed by polymerization of the polymerizable compound decreases. By contrast, the haze value decreases as the compatibility increases. A higher haze value indicates that the resin formed by polymerization of the polymerizable compound is more likely to form a porous structure. In the present embodiment, if the rate of increase of the haze value is 1.0% or more, the resin and the porogen are determined to be in an incompatible state, and if the rate of increase of the haze value is less than 1.0%, the resin and the porogen are determined to be in a compatible state. A device used for the measurement is described below.
Haze measurement device: HAZE METER NDH5000, manufactured by Nippon Denshoku Industries Co., Ltd.

### —Polymerization Initiator—

The polymerization initiator is a material that can generate active species such as radicals and cations by energy such as light and heat to initiate polymerization of the polymerizable compound. Examples of the polymerization initiator include, but are not limited to, known radical polymerization initiators, cationic polymerization initiators, and base generators. Each of these may be used alone or in combination with others. Among these, photoradical polymerization initiators are preferable.

Photoradical generators may be used as the photoradical polymerization initiators.

Examples of photoradical generators that can be suitably used include, but are not limited to, photoradical polymerization initiators such as Michler's ketone and benzophenone known by the trade names IRGACURE and DAROCUR. More specific examples of the photoradical generators include, but are not limited to, benzophenone and acetophenone derivatives such as α-hydroxy- or α-aminoacetophenone, 4-aroyl-1,3-dioxolane, benzyl ketal, 2,2-diethoxyacetophenone, p-dimethylaminoacetophenone, p-dimethylaminopropiophenone, benzophenone, 2-chlorobenzophenone, pp′-dichlorobenzophenone, pp′-bisdiethylaminobenzophenone, Michler's ketone, benzyl, benzoin, benzyl dimethyl ketal, tetramethylthiuram monosulfide, thioxanthone, 2-chlorothioxanthone, 2-methylthioxanthone, azobisisobutyronitrile, benzoin peroxide, di-tert-butyl peroxide, 1-hydroxycyclohexylphenyl ketone, 2-hydroxy-2-methyl-1-phenyl-1-one, 1-(4-isopropylphenyl)-2-hydroxy-2-methylpropane-1-one, methylbenzoyl formate, benzoin isopropyl ether, benzoin methyl ether, benzoin ethyl ether, benzoin ether, benzoin isobutyl ether, benzoin n-butyl ether, benzoin n-propyl, 1-hydroxy-cyclohexyl-phenyl-ketone, 2-benzyl-2-dimethylamino-1-(4-morpholinophenyl)-butanone-1,1-hydroxy-cyclohexyl-phenyl-ketone, 2,2-dimethoxy-1,2-diphenylethane-1-one, bis(15-2,4-cyclopentadiene-1-yl)-bis(2,6-difluoro-3-(1H-pyrrole-1-yl)-phenyl) titanium, bis(2,4,6-trimethylbenzoyl)-phenylphosphine oxide, 2-methyl-1-[4-(methylthio)phenyl]-2-morpholinopropane-1-one, 2-hydroxy-2-methyl-1-phenyl-propane-1-one (DAROCUR 1173), bis(2,6-dimethoxybenzoyl)-2,4,4-trimethyl-pentylphosphine oxide, 1-[4-(2-hydroxyethoxy)-phenyl]-2-hydroxy-2-methyl-1-propane-1-one monoacylphosphine oxide, bisacylphosphine oxide, titanocene, fluorescein, anthraquinone, thioxanthone, or xanthone, lophine dimer, trihalomethyl compounds or dihalomethyl compounds, active ester compounds, and organoboron compounds.

Further, photo-crosslinking type radical generators such as bisazide compounds may be provided simultaneously. If polymerization is performed by heat, thermal polymerization initiators such as azobisisobutyronitrile (AIBN), which is a typical radical generator, can be used.

To obtain a sufficient curing rate, the content of the polymerization initiator is preferably 0.05 mass % or more and 10.0 mass % or less, and more preferably 0.5 mass % or more and 5.0 mass % or less, when the total amount of the polymerizable compound is 100.0 mass %.

### —Physical Properties of Liquid Composition—

From the viewpoint of workability when applying the liquid composition, the viscosity of the liquid composition at 25° C. is preferably 1.0 mPa s or more and 150.0 mPa s or less, more preferably 1.0 mPa s or more and 30.0 mPa s or less, and particularly preferably 1.0 mPa s or more and 25.0 mPa s or less. If the viscosity of the liquid composition is 1.0 mPa s or more and 30.0 mPa s or less, the liquid composition exhibits excellent dischargeability even when applied to an inkjet method. The viscosity can be measured with a viscometer (device name: RE-550L, manufactured by Toki Sangyo Co., Ltd.) and the like.

### <<Method of Manufacturing Laminate for Battery>>

A method of manufacturing a laminate for a battery according to the present embodiment includes an insulating layer forming step of applying a liquid composition on a first electrode to form an insulating layer, and an electrode placement step of placing a second electrode on the first electrode on which the insulating layer is formed. The insulating layer forming step and the electrode placement step are implemented by a conveyance series.

The phrase “on the first electrode” as used herein includes “on a current collector”, “on an electrode mixture layer”, or both.

For example, in a case where the first electrode is formed by a current collector, the insulating layer is formed on the current collector. In a case where the first electrode is formed by a current collector and an electrode mixture layer formed on the current collector, the insulating layer may be formed on the electrode mixture layer, or the insulating layer may be formed on the current collector exposed from the electrode mixture layer and on the electrode mixture layer.

Thus, the insulating layer forming step and the electrode placement step are performed in a conveyance series, so that it is possible to prevent the laminate for a battery from breaking in an electrode manufacturing process. That is, the insulating layer is a member that is susceptible to damage such as cracks, and thus, it is preferable to place the second electrode on the insulating layer at an early stage after the insulating layer is formed. The insulating layer forming step and the electrode placement step are performed in a conveyance series, so that the second electrode can be placed on the insulating layer at an early stage after the insulating layer is formed. Therefore, the second electrode functions as a protective member that protects the insulating layer, and thus, it is possible to prevent the laminate for a battery from breaking.

As used in the present specification and claims, the phrase “a conveyance series” refers to steps performed in one conveyance process. For example, if the first electrode is conveyed by roll conveyance, a conveyance series means that the insulating layer forming step and the placement step are performed in one conveyance process. From the viewpoint of preventing the laminate for a battery from breaking, as described above, the conveyance series may include a case where the placement step is performed immediately after conveyance including the insulating layer forming step by which this effect is exhibited. The term “roll conveyance” as used herein refers to a method of feeding while tension is applied between a conveyance start point and a conveyance end point, and if desired, a supporting member such as a guide roll may be used to support a member to be conveyed. The roll conveyance includes, but is not limited to, conveyance by a roll-to-roll method. The roll conveyance includes, for example, a case where a member to be conveyed is wound in a roll shape at the conveyance start point and the member to be conveyed is not wound in a roll shape at the conveyance end point.

In a case where the first electrode is conveyed by using a belt, whether the belt is a single belt or includes a plurality of belt parts is not used as a basis for determining whether the process is a conveyance series. For example, even for a plurality of belts, continuous movement of the first electrode from one belt to another belt is regarded as a conveyance series.

The method of manufacturing the laminate for a battery according to the present embodiment may include, if desired, an electrode mixture layer forming step of forming an electrode mixture layer on a current collector, an irradiation step of irradiating the liquid composition with active energy rays, a removal step of removing a solvent contained in the liquid composition, and/or an electrode processing step of processing, after placement of the second electrode, the electrode to form a cell. In this case, for example, the irradiation step may be performed in-between the insulating layer forming step and the electrode placement step, as long as the insulating layer forming step and the placement step are a series of steps.

Preferably, the first electrode is a negative electrode and the second electrode is a positive electrode. Placing a positive electrode on a negative electrode is preferable in that no useless region is created in each electrode, so that the productivity can be increased, and the safety of the battery can be enhanced.

### <Insulating Layer Forming Step>

The insulating layer forming step is a step of forming an insulating layer including an organic layer and/or an inorganic layer on an application target, which is the first electrode. The insulating layer forming step includes an insulating layer forming liquid application step of applying a liquid composition to an application target, which is the first electrode, to form an insulating layer forming liquid composition layer, and may include, if desired, an irradiation step of irradiating the liquid composition with active energy rays and a removal step of removing a solvent contained in the liquid composition. As the insulating layer, an organic layer is preferable from the viewpoint of low weight and functions to be imparted by a temperature change, and an inorganic layer is preferable from the viewpoint of robustness and heat resistance.

In the insulating layer forming step, the insulating layer may be formed into a shape having an uneven pattern including a concave portion and a convex portion as illustrated in FIG. 10. The convex portion is preferably formed outside a region where the second electrode is placed. In the example of FIG. 10, a thick film region 11b of the insulating layer is the convex portion, and a thin film region 11a of the insulating layer exposed inside the thick film region 11b is the concave portion.

### <Insulating Layer Forming Liquid Application Step>

The insulating layer forming liquid application step is a step of applying an insulating layer forming liquid composition containing an organic compound and/or an inorganic compound, a solvent or a dispersion liquid, and the like to an application target, which is the first electrode. The applied liquid composition preferably forms, on the application target, a liquid composition layer that is a liquid film of the liquid composition. A method of applying the liquid composition is not particularly limited. Examples of the method include, but are not limited to, spin coating, casting, micro gravure coating, gravure coating, bar coating, roll coating, wire bar coating, dip coating, slit coating, capillary coating, spray coating, nozzle coating, and various printing methods such as gravure printing, screen printing, flexographic printing, offset printing, reverse printing, and inkjet printing. Among these, a liquid discharge method such as inkjet printing is preferable from the viewpoint that a position to which the liquid composition is applied can be controlled.

### <Irradiation Step>

The irradiation step is a step of irradiating the liquid composition applied in the liquid application step with active energy rays. In particular, in the case of a liquid composition that causes polymerization-induced phase separation, the irradiation step increases the porosity of the insulating layer, which is the finally manufactured porous resin, and thus, the uptake of fluids such as a liquid or a gas is improved in the porous resin. Specifically, by irradiating the liquid composition with active energy rays, a porous precursor having a porous structure is formed that serves as a basis for forming a porous resin having a high porosity.

The active energy rays are not particularly limited, as long as the active energy rays can impart energy for promoting a polymerization reaction of the polymerizable compound. Examples of the active energy rays include, but are not limited to, ultraviolet rays, electron beams, α-rays, β-rays, γ-rays, and X-rays. Among these, ultraviolet rays are preferable.

Particularly in a case where a light source having high energy is used, the polymerization reaction can proceed without using a polymerization initiator.

A reason for forming the porous precursor by the irradiation step will be described below for a case where the liquid composition causes polymerization-induced phase separation.

As described above, if a porous resin is formed by polymerization-induced phase separation, a structure, properties, and the like of the porous resin change based on the polymerization conditions. For example, if a porous resin is formed under conditions in which a liquid composition is irradiated with active energy rays having high irradiation intensity to promote the polymerization of the polymerizable compound, the polymerization is proceeds before sufficient phase separation occurs, and thus, it is more difficult to manufacture a porous resin having high porosity.

Therefore, to form a porous resin having high porosity, the irradiation intensity of the active energy rays for irradiation is set not too high. Specifically, the irradiation intensity of the active energy rays is preferably 1 W/cm2 or less, more preferably 300 mW/cm2 or less, and still more preferably 100 mW/cm2 or less. However, if the irradiation intensity of the active energy rays is too low, the phase separation proceeds excessively, which is likely to cause variations and coarsening of the porous structure, and also increases the irradiation time, resulting in reduced productivity. Accordingly, the irradiation intensity is preferably 10 mW/cm2 or more, and more preferably 30 mW/cm2 or more.

### <Removal Step>

The removal step is a step of removing a solvent or a dispersion liquid from the liquid composition. A method of removing the solvent or the dispersion liquid is not particularly limited. Examples of the method include, but are not limited to, a method of removing the solvent or the dispersion liquid from the porous resin by heating. In this case, heating under reduced pressure is preferable because the removal of the solvent or the dispersion liquid can be further promoted and the solvent or the dispersion liquid can be prevented from remaining in the insulating layer to be formed.

### <Electrode Placement Step>

The electrode placement step is a step of placing the second electrode on the first electrode on which the insulating layer is formed, as illustrated in FIG. 12, for example. In FIG. 12, reference numeral 9 denotes a current collector of the first electrode, reference numeral 1b denotes the thick film region of the insulating layer, reference numeral 12 denotes a current collector of the second electrode, and reference numeral 13 denotes an active material of the second electrode. A method of placing the second electrode is not particularly limited, but if a placement region is not suitable, a short circuit may occur between the first electrode and the second electrode. Therefore, the electrode placement step preferably includes an alignment step of adjusting a placement position of the second electrode after the insulating layer is formed on the first electrode. In addition, to prevent misalignment after the second electrode is placed, an adhesive or a sticky material may be applied to the first electrode and/or the second electrode before the second electrode is placed.

### <Electrode Mixture Layer Forming Step>

The electrode mixture layer forming step is a step of forming an electrode mixture layer on an application target, which is the first electrode. The electrode mixture layer forming step includes an electrode mixture layer forming liquid application step of forming an electrode mixture layer forming liquid composition layer on the application target, which is the first electrode, and a removal step of removing a solvent contained in the liquid composition.

### <Electrode Mixture Layer Forming Liquid Application Step>

The electrode mixture layer forming liquid application step is a step of applying, to the application target, which is the first electrode, an electrode mixture layer forming liquid composition containing a powdery active material, a catalyst composition, a dispersion liquid, and the like. The applied liquid composition preferably forms, on the application target, a liquid composition layer that is a liquid film of the liquid composition. A method of applying the liquid composition is not particularly limited. Examples of the method include, but are not limited to, spin coating, casting, micro gravure coating, gravure coating, bar coating, roll coating, wire bar coating, dip coating, slit coating, capillary coating, spray coating, nozzle coating, and various printing methods such as gravure printing, screen printing, flexographic printing, offset printing, reverse printing, and inkjet printing. Among these, a liquid discharge method such as inkjet printing is preferable from the viewpoint that a position to which the liquid composition is applied can be controlled.

### <Conveyance Step>

A conveyance step is a step of conveying the first electrode. The conveyance step preferably includes roll conveyance in which no conveyance belt is used, from the viewpoint that a contact region between the first electrode or the insulating layer and a conveyance device can be reduced in the conveyance step, which suppresses damage to the first electrode or the insulating layer caused by friction between the first electrode or the insulating layer and the conveyance device.

### <Electrode Processing Step>

The electrode processing step is a step of processing the first electrode after the insulating layer forming step. In the electrode processing step, for example, in the first electrode on which the second electrode is placed, the first electrode can be cut to manufacture an electrode laminate in which the second electrode is placed on the first electrode on which the insulating layer is formed. The electrode processing step preferably includes cutting the first electrode so that an area of the first electrode is larger than an area of the second electrode. This makes it possible to prevent a cut end portion of the first electrode from being short-circuited with an end portion of the second electrode.

In a case where the insulating layer contains a material having a melting point or a glass transition temperature, the electrode processing step includes, for example, manufacturing a plurality of electrode laminates in which the second electrode is placed on the first electrode on which the insulating layer is formed, and at least partially bonding one electrode laminate and another electrode laminate by heating. For example, if each electrode laminate includes the thick film region 11b of the insulating layer as illustrated in FIG. 10, electrode laminates positioned above and below each other may be arranged so as to face each other, and thick film regions of the facing electrode laminates may be heat-bonded to each other.

In the electrode processing step, for example, the first electrode on which the second electrode is placed can be laminated or wound to manufacture a laminate or a wound body. If the first electrode on which the second electrode is placed is laminated or wound, the first electrode may be cut at an appropriate timing.

An example of a laminating method includes, but is not limited to, a method of cutting the first electrode on which the second electrode is placed into a plurality of sheets to manufacture a plurality of electrode laminates, and laminating the plurality of electrode laminates. As illustrated in FIG. 13, another example of the laminating method includes, but is not limited to, a method of laminating a first electrode with second electrodes spaced apart thereon so that the first electrode is folded in a zigzag structure. In FIG. 13, reference numeral 9 denotes the current collector of the first electrode, reference numeral 11b denotes the thick film region of the insulating layer, reference numeral 12 denotes the current collector of the second electrode, and reference numeral 13 denotes the active material of the second electrode.

The winding can be performed, for example, by using an apparatus for manufacturing a laminate for a battery (described later) illustrated in FIG. 2. That is, a second electrode having a roll shape can be supplied by a second electrode conveyance device 4b onto a first electrode 6 being conveyed, to continuously laminate the second electrode on the first electrode 6, and the resulting laminate can be wound by an electrode processing unit 500 positioned downstream of an electrode placement unit 400.

When the number of layers laminated in a zigzag structure or the number of turns wound in a winding structure reaches an intended number, an intended laminate or wound body can be obtained by cutting.

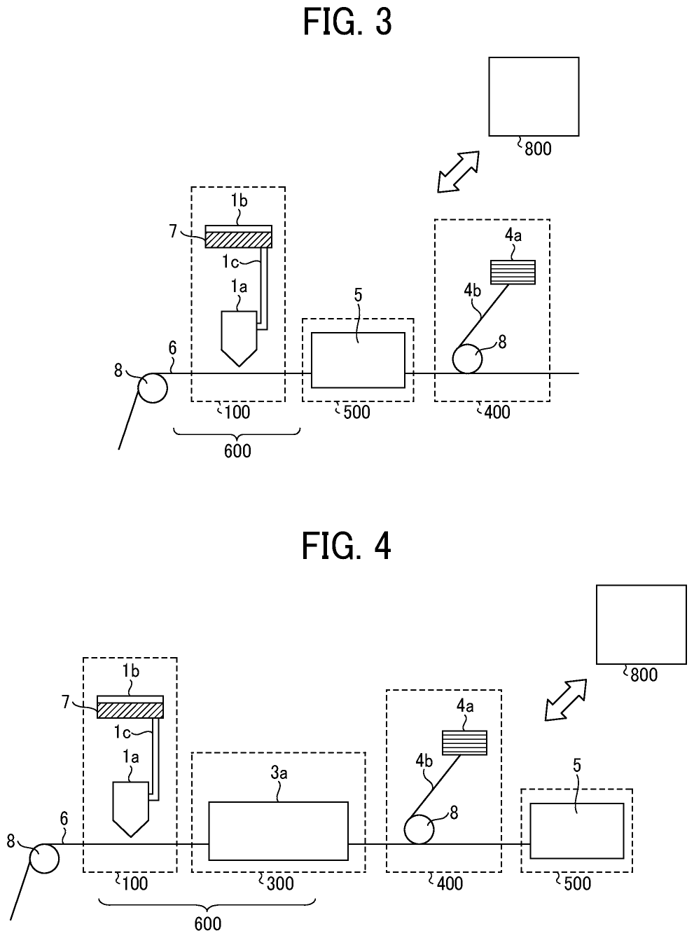

The electrode processing step may be performed between the insulating layer forming step and the placement step. That is, the electrode placement step may be performed immediately after the electrode processing step. For example, in the electrode processing step, the first electrode is cut before the second electrode is placed thereon, and the electrode placement step can be performed immediately after the first electrode is cut. The phrase “immediately after” as used herein means that the electrode processing step and the electrode placement step are included in a series of steps, and between the electrode processing step and the electrode placement step, the cut first electrode does not temporarily move to another position or the like. That is, the electrode processing step is provided between the insulating layer forming step and the placement step, and the electrode placement step is performed immediately after the electrode processing step, which means that these steps are included in a conveyance series according to the present embodiment. For example, the flow of steps described above can be realized by an apparatus for manufacturing a laminate for a battery illustrated in FIG. 3 (described later).

The electrode processing step may be performed between the insulating layer forming step and the placement step, and a second electrode processing step may be performed after the placement step. For example, an electrode laminate in which a second electrode is placed on the insulating layer of the cut first electrode may be laminated in the second electrode processing step. Alternatively, an electrode laminate in which a plurality of second electrodes are placed on the insulating layer of the cut first electrode may be wound in the second electrode processing step.

The electrode placement step is performed immediately after the electrode processing step, so that the second electrode can be placed on the insulating layer at an early stage after the insulating layer is formed. Therefore, the second electrode functions as a protective member that protects the insulating layer, and thus, it is possible to prevent the laminate for a battery from breaking.

### <<Apparatus for Manufacturing Laminate for Battery>>

An apparatus for manufacturing a laminate for a battery according to the present embodiment includes an insulating layer forming unit that applies a liquid composition on a first electrode to form an insulating layer, and an electrode placement unit that places a second electrode on the first electrode on which the insulating layer is formed. The insulating layer forming unit and the electrode placement unit are arranged in a conveyance series region where the first electrode is conveyed. The apparatus for manufacturing a laminate for a battery according to the present embodiment may include, if desired, an irradiation unit that irradiates the liquid composition with active energy rays, a removal unit that removes a solvent contained in the liquid composition, and an electrode processing unit that processes, after placement of the second electrode, the electrodes to form a cell.

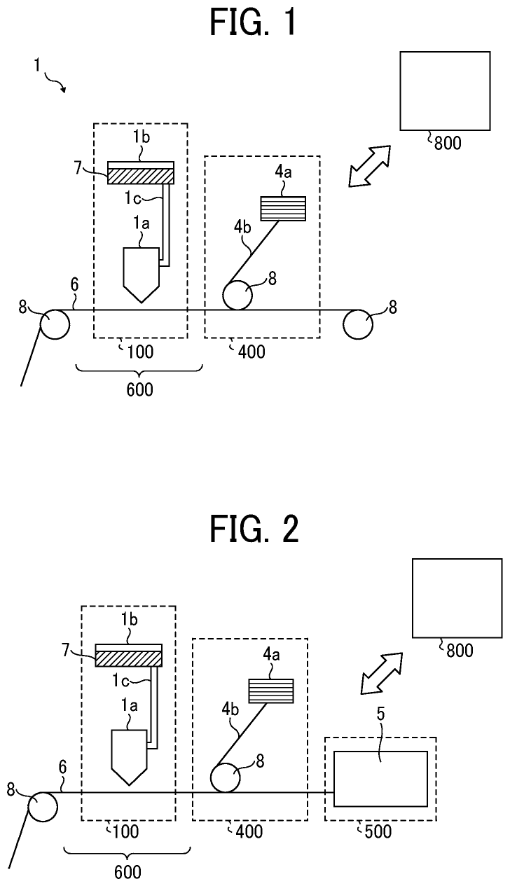

The apparatus for manufacturing a laminate for a battery will be described in detail with reference to FIGS. 1 to 9. FIG. 1 is a schematic diagram illustrating an example of the apparatus for manufacturing a laminate for a battery.

A battery laminate manufacturing apparatus 1, which is an example of the apparatus for manufacturing a laminate for a battery, is an apparatus for manufacturing an electrode by using the above-described liquid composition. The battery laminate manufacturing apparatus 1 includes an insulating layer forming unit 600 including a liquid application unit 100 that applies a liquid composition 7 onto the first electrode 6 to form an insulating layer, an electrode placement unit 400 that places a second electrode on the formed insulating layer by a conveyance series, and a control unit 800 that controls the insulating layer forming unit 600 and the electrode placement unit 400. The battery laminate manufacturing apparatus 1 further includes a roll unit 8. If the battery laminate manufacturing apparatus 1 includes a plurality of the roll units 8, a part or all of the roll units 8 may be rotated under the control of the control unit 800, and may function as a conveyance unit that conveys the first electrode 6 at a predetermined speed. Some of the roll units 8 may function as a guide roll that serves as a supporting member.

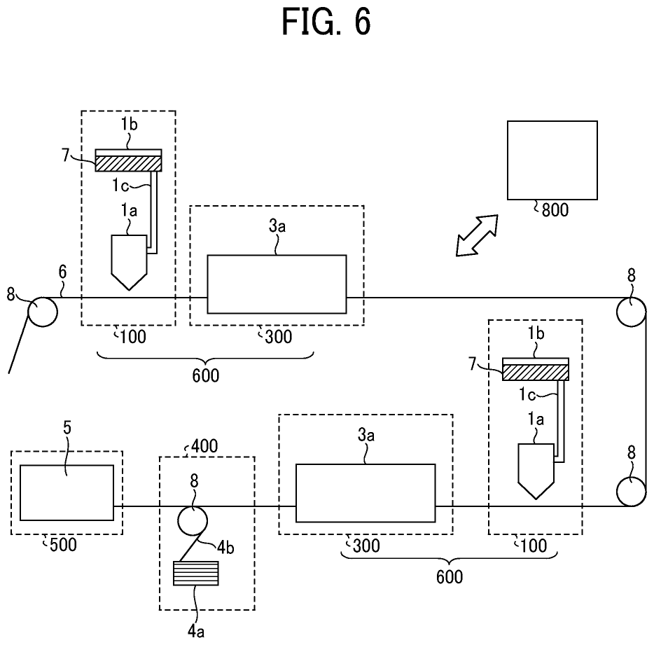

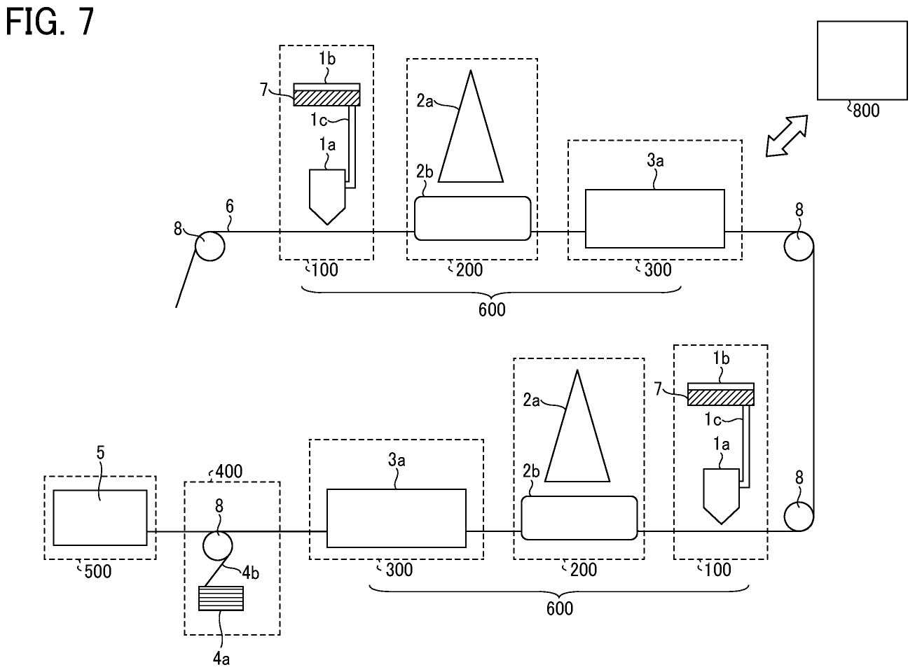

As illustrated in FIGS. 2 to 7, which are schematic diagrams illustrating examples of the apparatus for manufacturing a laminate for a battery, in addition to the configuration described for the battery laminate manufacturing apparatus 1, there may be provided an irradiation unit 200 that performs a step of activating a polymerization initiator in the liquid composition to obtain an insulating layer by polymerization of a polymerizable compound, a removal unit 300 that performs a step of heating the liquid composition to remove a solvent, the electrode processing unit 500 that processes the electrodes to form a cell after the second electrode is placed, and the like. The irradiation unit 200, the removal unit 300, and the electrode processing unit 500 are controlled by the control unit 800. The apparatuses for manufacturing a laminate for a battery illustrated in FIGS. 6 and 7 can apply the liquid composition onto both surfaces of the first electrode 6.

### <Insulating Layer Forming Unit>

The insulating layer forming unit 600 includes at least the liquid application unit 100 and may include the irradiation unit 200 and/or the removal unit 300, if desired. The insulating layer forming unit 600 may form the insulating layer into a shape having an uneven pattern including a concave portion and a convex portion, as illustrated in FIG. 10. The convex portion is preferably formed outside a region where the second electrode is placed.

### <Liquid Application Unit>

The liquid application unit 100 includes a printing device 1a that realizes an application step of applying the liquid composition onto the first electrode 6, a storage container 1b that contains the liquid composition, and a supply tube 1c that supplies the liquid composition stored in the storage container 1b to the printing device 1a.

The storage container 1b contains the liquid composition 7. The liquid application unit 100 discharges the liquid composition 7 from the printing device 1a to apply the liquid composition 7 onto the first electrode 6 and form a liquid composition layer in a thin film shape. The storage container 1b may be integrally formed with the battery laminate manufacturing apparatus 1, or may be detachable from the battery laminate manufacturing apparatus 1. The storage container 1b may be a container used for addition to a storage container integrally formed with the battery laminate manufacturing apparatus 1 or a storage container detachable from the battery laminate manufacturing apparatus 1.

The printing device 1a is not particularly limited, as long as the printing device 1a can apply the liquid composition 7. Examples of the printing device include, but are not limited to, any printing devices that support spin coating, casting, micro gravure coating, gravure coating, bar coating, roll coating, wire bar coating, dip coating, slit coating, capillary coating, spray coating, nozzle coating, and various printing methods such as gravure printing, screen printing, flexographic printing, offset printing, reverse printing, and inkjet printing.

The storage container 1b and the supply tube 1c may have any configuration by which it is possible to stably store and supply the liquid composition 7. A material forming the storage container 1b and the supply tube 1c preferably has a light-shielding property in a relatively short wavelength region of ultraviolet and visible light. Thus, if the liquid composition 7 contains a polymerizable compound, the polymerizable compound is prevented from being polymerized by external light.

### <Irradiation Unit>

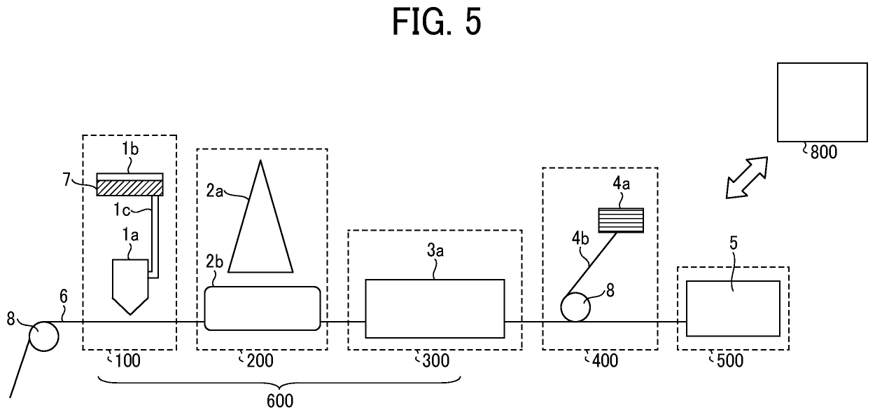

As illustrated in FIG. 5 for example, the irradiation unit 200 includes a light irradiation device 2a that irradiates the liquid composition with active energy rays such as heat and light to polymerize a polymerizable compound, and an inert polymerization gas circulating device 2b that circulates an inert polymerization gas. If the liquid composition formed by the liquid application unit 100 contains a polymerizable compound, the light irradiation device 2a irradiates the liquid composition with light in the presence of an inert polymerization gas to form an insulating layer.

The light irradiation device 2a is not particularly limited and can be appropriately selected according to an absorption wavelength of a photopolymerization initiator contained in the liquid composition layer, as long as the light irradiation device 2a can initiate and promote the polymerization of compounds contained in the liquid composition layer. Examples of the light irradiation device 2a include, but are not limited to, ultraviolet light sources such as a high-pressure mercury lamp, a metal halide lamp, a hot cathode tube, a cold cathode tube, and an LED. However, light having a shorter wavelength generally reaches a deeper portion more easily, and thus, the light source is preferably selected according to a thickness of the porous film to be formed.

Next, the inert polymerization gas circulating device 2b lowers the concentration of polymerization-active oxygen in the atmosphere to promote a polymerization reaction of the polymerizable compound in the vicinity of a surface of the liquid composition layer without inhibition by oxygen. The inert polymerization gas is not particularly limited, as long as the inert polymerization gas satisfies the above-described function. Examples of the inert polymerization gas include, but are not limited to, nitrogen, carbon dioxide, and argon.

A flow rate of the inert polymerization gas is determined so that an inhibition reduction effect is efficiently obtained. The 02 concentration is preferably less than 20% (an environment where the oxygen concentration is lower than in the atmosphere), more preferably 0% or more and 15% or less, and still more preferably 0% or more and 5% or less.

The inert polymerization gas circulating device 2b preferably includes a temperature adjusting means that can adjust the temperature, to provide stable polymerization promoting conditions.

### <Removal Unit>

As illustrated in FIG. 4 for example, the removal unit 300 includes a heating device 3a. The heating device 3a heats and dries a solvent remaining in the formed insulating layer to remove the solvent. The removal unit 300 may perform a solvent removing step under reduced pressure.

The removal unit 300 may heat and dry photopolymerization initiator remaining in the insulating layer by the heating device 3a to remove the photopolymerization initiator.

The heating device 3a is not particularly limited as long as the heating device 3a satisfies the above-described function. Examples of the heating device include, but are not limited to, an IR heater and a hot air heater.

It is possible to appropriately select a heating temperature and a heating time according to the boiling point of the solvent included in the insulating layer or the thickness of the formed film.

### <Electrode Placement Unit>

As illustrated in FIGS. 1 to 7, the electrode placement unit 400 includes a second electrode container 4a, and the second electrode conveyance device 4b places the second electrode on the insulating layer formed on the first electrode. The second electrode container 4a may be a wound electrode or a sheet electrode. The second electrode conveyance device 4b is not particularly limited, as long as the second electrode conveyance device 4b can convey the electrode. An example of the second electrode conveyance device 4b includes, but is not limited to, a device that conveys the electrode by an attraction mechanism. The electrode placement unit 400 may include, if desired, an alignment mechanism that adjusts a placement position of the second electrode by using a built-in camera or the like.

### <Electrode Processing Unit>

The electrode processing unit 500 processes the first electrode on which the insulating layer is formed. For example, as illustrated in FIG. 2, the electrode processing unit 500 includes an electrode processing device 5. For example, the electrode processing unit 500 winds or laminates the first electrode on which the second electrode is placed. In the first electrode on which the second electrode is placed, the electrode processing unit 500 cuts the first electrode.

At this time, the electrode processing unit 500 preferably cuts the first electrode so that the area of the first electrode is larger than the area of the second electrode. This makes it possible to prevent a cut end portion of the first electrode from being short-circuited with an end portion of the second electrode. If the first electrode on which the second electrode is placed is wound or laminated, the electrode processing unit 500 may cut the first electrode at an appropriate timing.

In a case where the insulating layer contains a material having a melting point or a glass transition temperature, the electrode processing unit 500, for example, manufactures a plurality of electrode laminates in which the second electrode is placed on the first electrode on which the insulating layer is formed, and heats one electrode laminate and another electrode laminate so that the laminates at least partially bond together. The electrode processing unit 500 may cut the first electrode before the second electrode is placed. In this case, a second electrode processing unit may be provided to perform lamination or winding after the second electrode is placed.

Thus, the electrode processing unit 500 can perform electrode cutting, zigzag folding of the first electrode, lamination or winding, thermal adhesion between the laminated or wound first electrodes, and the like, according to an intended battery form.

### <Control Unit>

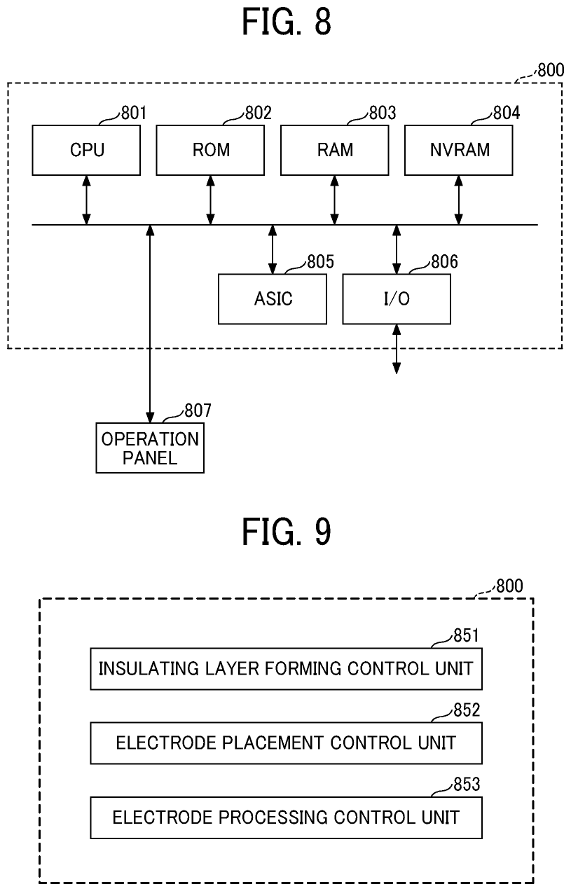

FIG. 8 is an example of a block diagram of main hardware of a control unit. As illustrated in FIG. 8, the control unit 800 includes a CPU 801, a ROM 802, a RAM 803, an NVRAM 804, an ASIC 805, an I/O 806, and an operation panel 807, for example.

The CPU 801 generally controls the apparatus for manufacturing a laminate for a battery. The ROM 802 stores a program executed by the CPU 801 and other fixed data. The RAM 803 temporarily stores data and the like relating to the manufacturing of the laminate for a battery. The NVRAM 804 is a non-volatile memory for holding data while the apparatus is disconnected from a power source. The ASIC 805 processes input/output signals for image processing and other control processes of the entire apparatus. The I/O 806 is an interface for inputting/outputting signals to/from the insulating layer forming unit 600, the electrode placement unit 400, and the like. The operation panel 807 receives an input of and displays information for the control unit 800.

FIG. 9 is an example of a diagram of main functional blocks of the control unit. As illustrated in FIG. 9, the control unit 800 includes an insulating layer forming control unit 851, an electrode placement control unit 852, and an electrode processing control unit 853 as functional blocks.

The insulating layer forming control unit 851 controls the insulating layer forming unit 600. For example, the insulating layer forming control unit 851 issues an instruction to the liquid application unit 100 to control a timing and an amount of application of the liquid composition. For example, if an insulating layer is formed by inkjet printing, the insulating layer forming control unit 851 issues an instruction to the liquid application unit 100 to apply the liquid composition at a predetermined timing, in a predetermined number of droplets, and under discharge conditions such as predetermined waveform data and a discharge frequency.

For example, the insulating layer forming control unit 851 issues an instruction to the irradiation unit 200 to control the timing, the irradiation amount, and the like when irradiating the liquid composition with active energy rays. For example, the insulating layer forming control unit 851 issues an instruction to the removal unit 300 to control the timing, the heating amount, and the like when heating and drying the solvent to remove the solvent remaining in the insulating layer.

For example, the electrode placement control unit 852 issues an instruction to the electrode placement unit 400 to control a timing for attracting the electrode, a speed of conveying the attracted electrode, and the like. If the electrode placement unit 400 includes an alignment mechanism, the electrode placement control unit 852 controls the alignment mechanism to adjust a placement position of the second electrode, based on position information from an image sensor such as a camera.

For example, if the first electrode is cut by using a laser, the electrode processing control unit 853 issues an instruction to the electrode processing unit 500 to control an amount of emitted light of the laser and to scan the laser, based on position information from an image sensor such as a camera. For example, the electrode processing control unit 853 issues an instruction to the electrode processing unit 500 to control a start timing, an end timing, and the like of zigzag folding, lamination, winding, and the like of the first electrode. For example, the electrode processing control unit 853 issues an instruction to the electrode processing unit 500 to control the heating temperature and the heating time for thermally bonding the laminated or wound first electrodes.

Specific examples of a cell and the like will be described below with reference to Examples and Comparative Examples, but the present embodiment is in no way limited to these Examples.

### EXAMPLES

First, a negative electrode and a positive electrode to be used in each Example and each Comparative Example were manufactured.

### <Manufacturing of Negative Electrode>

A negative electrode coating material for forming a negative electrode mixture layer was prepared by mixing 97.0 mass % of graphite, 1.0 mass % of a thickener (carboxymethyl cellulose), 2.0 mass % of polymer (styrene butadiene rubber), and 100.0 mass % of water as a solvent. The negative electrode coating material was coated onto both surfaces of a copper foil base and then dried to obtain a negative electrode including a negative electrode mixture layer having a target weight of 9.0 mg/cm2 on each side. Next, the obtained negative electrode was pressed using a roll press to obtain a volume density of 1.6 g/cm3 to obtain a negative electrode to be used. At this time, the total film thickness of the negative electrode was 112.0 μm.

### <Manufacturing of Positive Electrode>

92.0 mass % of lithium nickel oxide (NCA) were prepared as a positive electrode active material, 3.0 mass % of acetylene black were prepared as a conductive material, and 5.0 mass % of polyvinylidene fluoride (PVDF) were prepared as a binder. Subsequently, these materials were dispersed in N-methylpyrrolidone (NMP) to prepare a positive electrode coating material. The positive electrode coating material was coated onto both surfaces of an aluminum foil base and then dried to obtain a positive electrode including a positive electrode mixture layer having a target weight of 15.0 mg/cm2 on each side. Next, the obtained positive electrode was pressed using a roll press to a volume density of 2.8 g/cm3 to obtain a positive electrode to be used. At this time, the total film thickness of the positive electrode was 132.0 μm. Finally, a die punching machine (punching area: 47.0 mm×27.0 mm) was used to punch out the positive electrode.

### Example 1

### —Adjustment of Insulating Layer Forming Liquid Composition—

Materials were mixed in the proportions described below to prepare an insulating layer forming liquid composition. 29.0 mass % of tricyclodecanedimethanol diacrylate (manufactured by Daicel-Allnex Ltd.) as a polymerizable compound A, 70.0 mass % of dipropylene glycol monomethyl ether (manufactured by Kanto Chemical Industry Co., Ltd.) as a solvent (porogen), and 1.0 mass % of IRGACURE 184 (manufactured by BASF) as a polymerization initiator were mixed to obtain an insulating layer forming liquid composition.

### <Formation of Insulating Layer, Placement of Second Electrode>

The apparatus for manufacturing a laminate for a battery illustrated in FIG. 6 was used to form an insulating layer and place a second electrode.

### —Formation of Insulating Layer—

First, a liquid composition for forming a functional layer was filled into a die coat printing device. A negative electrode serving as the first electrode was prepared in a roll shape having a current collector width of 60 mm and a mixture layer width of 50 mm. Subsequently, the negative electrode was conveyed at 50 mm/sec, and the discharge amount of the liquid composition for the negative electrode was controlled to form an insulating layer having a film thickness of 20.0 μm on both surfaces of the negative electrode mixture layer. Immediately after that, in an N2 atmosphere, an application region of the insulating layer was irradiated with UV (light source: UV-LED (trade name: FJ800, manufactured by Phoseon Technology), wavelength: 365 nm, irradiation intensity: 30 mW/cm2, irradiation time: 20 s) to cure the insulating layer.

Next, the cured product was heated at 120° C. for 1 minute by using a hot air drying oven to remove the solvent, and thus, a first electrode having an insulating layer was obtained.

### —Placement of Second Electrode—

After the formation of the insulating layer, the positive electrode was used as the second electrode and placed to be positioned on the insulating layer (thin film region) of the first electrode having the insulating layer. After that, the first electrode having the insulating layer and on which the second electrode is placed was cut into a size of 60.0 mm×30.0 mm to obtain a first electrode set.

### [Evaluation 1: Film Impact Resistance Test]

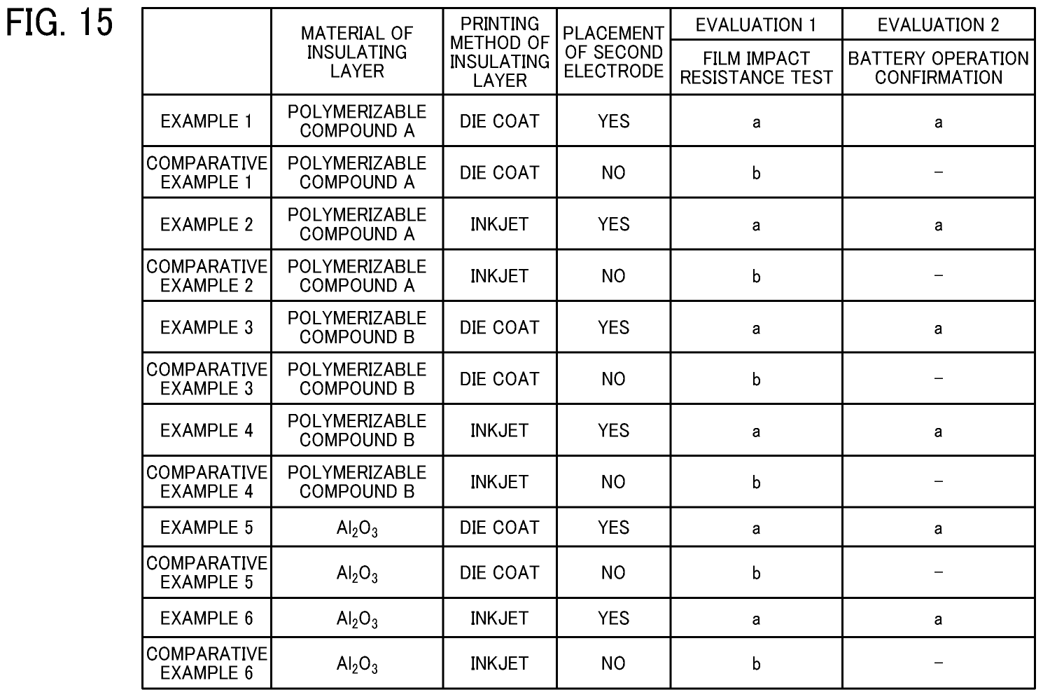

The obtained first electrode set was subjected to a strength test according to evaluation procedures 1-1 to 1-3 below. The results are presented in FIG. 15.

### Procedure 1-1: Load Application

A pin was pressed from above against the obtained first electrode set to apply a load to the first electrode set.

In Comparative Examples 1 to 8, the second electrode is not placed, and thus, instead of the first electrode set, the first electrode having the insulating layer on which the second electrode is not placed was subjected to the strength test.

### Procedure 1-2: Manufacturing of Battery Before Injection of Electrolyte Solution

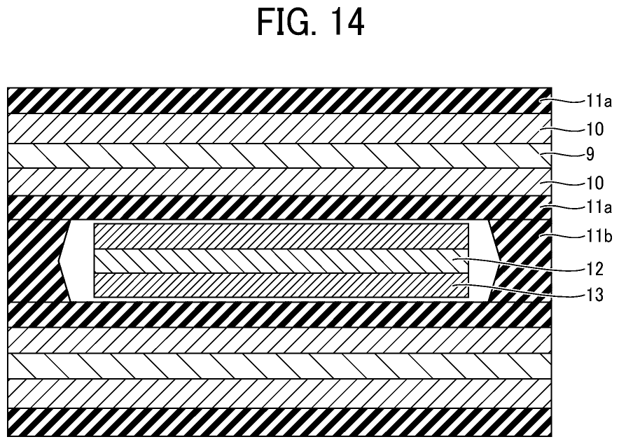

In Comparative Examples 1 to 8, positive electrodes were first laminated so as to face each other. The resulting laminate was sealed using a laminate outer packaging material as an outer packaging to manufacture a battery before injection of an electrolyte solution, as illustrated in FIG. 14.

### Procedure 1-3: Short-Circuit Evaluation Between Positive and Negative Electrodes

A digital multimeter was used to confirm whether the positive and negative electrodes in the obtained battery were short-circuited.

The determination criteria for a short circuit were set as follows, based on the resistance value displayed on the digital multimeter.
a: No short circuit (30 MΩ or more)
b: Short circuit (less than 30 MΩ)

### [Evaluation 2: Battery Operation Confirmation]

The battery obtained in Evaluation 1 before injection of an electrolyte solution was subjected to a battery operation test according to evaluation procedures 2-1 and 2-2 below. However, if it was determined in Evaluation 1 that there is a short circuit, Evaluation 2 was not performed. The results are presented in FIG. 15.

### Procedure 2-1: Manufacturing of Battery

The battery obtained in Evaluation 1 before injection of the electrolyte solution was vacuum-dried at 120° C. for 12 hours, and the electrolyte solution was injected. At that time, in Example 4 and Comparative Example 4, thick film regions of first electrodes positioned above and below each other in the laminate were heat-bonded at electrode end portions. A solution obtained by adding LiPF6, which is an electrolyte, to a mixture of ethylene carbonate (EC) and dimethyl carbonate (DMC) (a mixture having a mass ratio of “EC: DMC=1:1”) so that the concentration of LiPF6 is 1.5 mol/L, was used as the electrolyte solution.

### Procedure 2-2: Measurement of Initial Battery Capacity

A positive electrode lead wire and a negative electrode lead wire of the manufactured battery were connected to a charge/discharge test device. The battery was charged at a constant current and a constant voltage with a maximum voltage of 4.2 V and a current rate of 0.2 C for 5 hours. After charging was completed, the battery was left to stand in a constant temperature bath at 40° C. for 5 days. After that, the battery was discharged to 2.5 V at a constant current with a current rate of 0.2 C. Subsequently, the battery was charged at a constant current and a constant voltage with a maximum voltage of 4.2 V and a current rate of 0.2 C for 5 hours, followed by a pause of 10 minutes, and was then discharged to 2.5 V at a constant current with a current rate of 0.2 C. The discharge capacity at that time was defined as an initial capacity.
a: Confirmation that the initial capacity is less than +10% of the theoretical capacity
b: Confirmation that the initial capacity is +10% or more of the theoretical capacity

### Comparative Example 1

A first electrode having an insulating layer was obtained similarly to Example 1, except that the placement of the second electrode in Example 1 was changed to the procedure described below. Subsequently, Evaluations 1 and 2 were performed similarly to Example 1. The results are presented in FIG. 15.

### —Placement of Second Electrode—

After the insulating layer was formed, the positive electrode was not placed as the second electrode, and the first electrode was cut into a size of 60.0 mm×30.0 mm to obtain first electrodes.

### Example 2

A first electrode set having an insulating layer on which the second electrode is placed was obtained similarly to Example 1, except that the formation of the insulating layer in Example 1 was changed to the procedure described below. Subsequently, Evaluations 1 and 2 were performed similarly to Example 1. The results are presented in FIG. 15.

### —Formation of Insulating Layer—

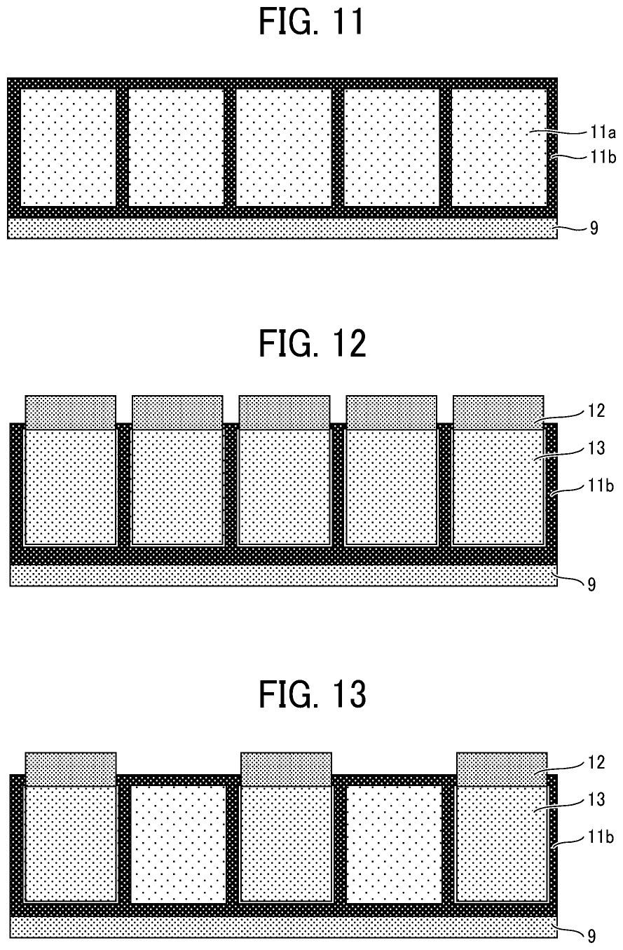

The manufacturing apparatus illustrated in FIG. 7 was used to form an insulating layer and place a second electrode. First, a liquid composition for forming a functional layer was filled into an inkjet discharge device equipped with a GEN5 head (manufactured by Ricoh Printing Systems Ltd.). The discharge amount of the liquid composition with respect to the negative electrode was controlled to form an insulating layer (a thin film region) and an insulating layer (a thick film region) on both surfaces of the negative electrode mixture layer so as to obtain a shape of a pattern image illustrated in FIG. 11. The insulating layer (the thin film region) had an area of 47.0 mm×27.0 mm and a film thickness of 20.0 m, and the insulating layer (the thick film region) had a film thickness of 26.0 μm. Immediately after that, in an N2 atmosphere, the application region was irradiated with UV (light source: UV-LED (trade name: FJ800, manufactured by Phoseon Technology), wavelength: 365 nm, irradiation intensity: 30 mW/cm2, irradiation time: 20 s) to cure the application region. Next, the cured product was heated at 120° C. for 1 minute using a hot air drying oven to remove the porogen, and thus, an insulating layer was obtained.

### Comparative Example 2

A first electrode having an insulating layer was obtained similarly to Example 2, except that the placement of the second electrode in Example 2 was changed to the procedure described below. Subsequently, Evaluations 1 and 2 were performed similarly to Example 1. The results are presented in FIG. 15.

### —Placement of Second Electrode—

After the insulating layer was formed, the positive electrode was not placed as the second electrode, and the first electrode was cut into a size of 60.0 mm×30.0 mm to obtain first electrodes.

### Example 3

A first electrode set having an insulating layer on which the second electrode is placed was obtained similarly to Example 1, except that the formation of the insulating layer forming liquid composition in Example 1 was changed to the procedure described below. Subsequently, Evaluations 1 and 2 were performed similarly to Example 1. The results are presented in FIG. 15.

### —Formation of Insulating Layer Forming Liquid Composition—

39.0 mass % of EBECRYL 8402 (manufactured by Daicel-Allnex Ltd.) as a polymerizable compound B, 60.0 mass % of diisobutyl ketone (manufactured by Kanto Chemical Industry Co., Ltd.) as porogen, and 1.0 mass % of IRGACURE 819 (manufactured by BASF) as a polymerization initiator were mixed to obtain an insulating layer forming liquid composition.

### Comparative Example 3

A first electrode having an insulating layer was obtained similarly to Example 3, except that the placement of the second electrode in Example 3 was changed to the procedure described below. Subsequently, Evaluations 1 and 2 were performed similarly to Example 1. The results are presented in FIG. 15.

### —Placement of Second Electrode—

After the insulating layer was formed, the positive electrode was not placed as the second electrode, and the first electrode was cut into a size of 60.0 mm×30.0 mm to obtain first electrodes.

### Example 4

A first electrode set having an insulating layer on which the second electrode is placed was obtained similarly to Example 3, except that the formation of the insulating layer in Example 3 was changed to the procedure described below. Subsequently, Evaluations 1 and 2 were performed similarly to Example 1. The results are presented in FIG. 15.

### —Formation of Insulating Layer—

The manufacturing apparatus illustrated in FIG. 7 was used to form the insulating layer and place the second electrode.

A liquid composition for forming a functional layer was filled into an inkjet discharge device equipped with a GEN5 head (manufactured by Ricoh Printing Systems Ltd.). The discharge amount of the liquid composition with respect to the negative electrode was controlled to form an insulating layer (a thin film region) and an insulating layer (a thick film region) on both surfaces of the negative electrode mixture layer so as to obtain a shape of a pattern image illustrated in FIG. 11. The insulating layer (the thin film region) had an area of 47.0 mm×27.0 mm and a film thickness of 20.0 m, and the insulating layer (the thick film region) had a film thickness of 26.0 μm. Immediately after that, in an N2 atmosphere, the application region was irradiated with UV (light source: UV-LED (trade name: FJ800, manufactured by Phoseon Technology), wavelength: 365 nm, irradiation intensity: 30 mW/cm2, irradiation time: 20 s) to cure the application region. Next, the cured product was heated at 120° C. for 1 minute using a hot air drying oven to remove the porogen, and thus, an insulating layer was obtained.

### Comparative Example 4

A first electrode having an insulating layer was obtained similarly to Example 4, except that the placement of the second electrode in Example 4 was changed to the procedure described below. Subsequently, Evaluations 1 and 2 were performed similarly to Example 1. The results are presented in FIG. 15.

### —Placement of Second Electrode—

After the insulating layer was formed, the positive electrode was not placed as the second electrode, and the first electrode was cut into a size of 60.0 mm×30.0 mm to obtain first electrodes.

### Example 5

A first electrode set having an insulating layer on which the second electrode is placed was obtained similarly to Example 1, except that the formation of the insulating layer forming liquid composition in Example 1 was changed to the procedure described below. Subsequently, Evaluations 1 and 2 were performed similarly to Example 1. The results are presented in FIG. 15.

### —Formation of Insulating Layer Forming Liquid Composition—

A pre-dispersion liquid was prepared by mixing 40.0 mass % of α-alumina (having a primary particle diameter (D50) of 0.5 μm and a specific surface area of 7.8 g/m2) as an inorganic solid, 58.0 mass % of a mixed solution of dimethyl sulfoxide and ethylene glycol (DMSO-EG), and 2.0 mass % of MALIALIM HKM-150A (manufactured by NOF Corporation) as a dispersant. The pre-dispersion liquid was filled in a container together with zirconia beads ((D2 mm), and subjected to dispersion treatment at 1500 rpm for 3 minutes using a low temperature nano pulverizer NP-100 (manufactured by Thinky Corporation) to obtain a dispersion liquid. A 25 μm mesh filter was used to remove the zirconia beads from the obtained dispersion liquid to prepare an insulating layer forming liquid composition.

### Comparative Example 5

A first electrode having an insulating layer was obtained similarly to Example 5, except that the placement of the second electrode in Example 5 was changed to the procedure described below. Subsequently, Evaluations 1 and 2 were performed similarly to Example 1. The results are presented in FIG. 15.

### —Placement of Second Electrode—

After the insulating layer was formed, the positive electrode was not placed as the second electrode, and the first electrode was cut into a size of 60.0 mm×30.0 mm to obtain first electrodes.

### Example 6

A first electrode set having an insulating layer on which the second electrode is placed was obtained similarly to Example 1, except that the formation of the insulating layer in Example 1 was changed to the procedure described below. Subsequently, Evaluations 1 and 2 were performed similarly to Example 1. The results are presented in FIG. 15.

### —Formation of Insulating Layer—

The manufacturing apparatus illustrated in FIG. 7 was used to form the insulating layer and place a second electrode. A liquid composition for forming a functional layer was filled into an inkjet discharge device equipped with a GEN5 head (manufactured by Ricoh Printing Systems Ltd.). The discharge amount of the liquid composition with respect to the negative electrode was controlled to form on both surfaces of the negative electrode an application region having a shape of a pattern image illustrated in FIG. 11 in which an insulating layer (a thin film region) and an insulating layer (a thick film region) are defined as follows. The insulating layer (the thin film region) had an area of 47.0 mm×27.0 mm and a film thickness of 20.0 m, and the insulating layer (the thick region) had a film thickness of 26.0 μm. Immediately after that, in an N2 atmosphere, the application region was irradiated with UV (light source: UV-LED (trade name: FJ800, manufactured by Phoseon Technology), wavelength: 365 nm, irradiation intensity: 30 mW/cm2, irradiation time: 20 s) to cure the application region. Next, the cured product was heated at 120° C. for 1 minute using a hot air drying oven to remove the porogen, and thus, an insulating layer was obtained.

### Comparative Example 6

A first electrode having an insulating layer was obtained similarly to Example 6, except that the placement of the second electrode in Example 6 was changed to the procedure described below. Subsequently, Evaluations 1 and 2 were performed similarly to Example 1. The results are presented in FIG. 15.

### —Placement of Second Electrode—

After the insulating layer was formed, the positive electrode was not placed as the second electrode, and the first electrode was cut into a size of 60.0 mm×30.0 mm to obtain first electrodes.

From FIG. 15, it can be seen that both in Evaluation 1 and Evaluation 2, an evaluation of “a” is obtained for all Examples. That is, the results of FIG. 15 indicate that the placement of the second electrode improves the resistance of the film to impact, resulting in excellent battery characteristics. These results depend on whether the second electrode is placed, regardless of the type of material forming the insulating layer. That is, the insulating layer may be formed of an organic material or an inorganic material, as long as the material can form the insulating layer, and thus, the placement of the second electrode improves the resistance of the film to impact, resulting in excellent battery characteristics.

In a case where the polymerizable compound B or the like having a low glass transition temperature (Tg) was used as the material for the insulating layer, it was also confirmed that thick film regions of first electrodes positioned above and below each other in the laminate at electrode end portions were heat-bonded by heating after the second electrode was placed and laminated, and thus, it was possible to obtain a laminate in which electrode misalignment is unlikely to occur after lamination.

Note that, in recent years, there has been a rapid increase in demand for power storage elements such as batteries and power generation elements such as fuel cells having higher output, higher capacity, and a longer service life.

To achieve this, high-quality battery members are desired to improve stable characteristics and the safety of elements.

For example, it is desirable that functional layers such as an active material and an insulating layer that are present inside a battery are formed by a film having a uniform thickness to prevent variations in a battery reaction.

In addition, it is desirable that an edge portion of an electrode on which various types of functional layers are formed does not have burrs or the like that lead to puncturing of a separator inside the battery.

In addition to achieving such high-quality battery members, it is also desirable to realize high productivity.

For example, to realize high productivity, as described in PTL 2, a step of cutting or folding a conveyed base or a step of placing a counter electrode is introduced into a roll coating device for manufacturing a battery, so that it possible to make a battery production process more efficient and improve quality.

However, if the cutting step is performed during roll conveyance, contact between a conveyed member and a cutting blade tends to cause twists, wrinkles, and burrs at electrode end portions.

On the other hand, even if a roll conveyance speed is lowered during cutting to improve the quality of the electrode end portions, there is a problem in that variations occur in the thickness of the functional film during the application of the functional film due to the speed change during cutting, and thus, there is room for improvement of the quality.

In this case, a method of manufacturing a member for a battery includes a conveyance step of conveying a first base while changing a speed, and a functional film forming step of discharging a liquid composition onto the conveyed first base by a liquid discharge method to form a functional film. The method may include, if desired, an irradiation step of irradiating the liquid composition with active energy rays, a removal step of removing a solvent contained in the liquid composition, a base processing step of processing, after placement of a second base, the bases to form a cell, and the like.

### <Functional Film Forming Step>

The functional film forming step is a step of forming, on an application target that is the first base, a functional film including a conductive layer or an insulating layer.

The functional film forming step includes a liquid application step of applying a liquid composition onto an application target that is a conductive layer base or an insulating layer base, which is the first base, to form a liquid composition layer.

The functional film forming step may include, if desired, an irradiation step of irradiating the liquid composition with active energy rays, a removal step of removing a solvent contained in the liquid composition, and the like.

### <Liquid Application Step>

The liquid application step is a step of applying a liquid composition containing an organic compound and/or an inorganic compound, a solvent or a dispersion liquid, and the like to the application target, which is the first base.

The applied liquid composition preferably forms, on the application target, a liquid composition layer that is a liquid film of the liquid composition.

A method for applying the liquid composition is preferably a liquid discharge method such as inkjet printing.

Thus, even when the first base is conveyed at a variable speed, the discharge period, the discharge amount, and the like in the inkjet method can be changed instantaneously to form, on the first base, a functional film having less variations in the film thickness.

Therefore, it is preferable to change a signal for discharging the liquid composition in synchronization with the speed change of the conveyance step, and signals may be synchronized with each other.

### <Irradiation Step>

The irradiation step is a step of irradiating the liquid composition applied in the liquid application step with active energy rays.

In particular, in the case of a liquid composition that causes polymerization-induced phase separation, the irradiation step increases a porosity of the finally manufactured porous resin, and thus, the uptake of fluids such as a liquid or a gas is improved in the porous resin. Specifically, by irradiating the liquid composition with active energy rays, a porous precursor having a porous structure is formed that serves as a basis for forming a porous resin having a high porosity.

The active energy rays are not particularly limited, as long as the active energy rays can impart energy for promoting a polymerization reaction of the polymerizable compound. Examples of the active energy rays include, but are not limited to, ultraviolet rays, electron beams, α-rays, β-rays, γ-rays, and X-rays.

Among these, ultraviolet rays are preferable.

Particularly in a case where a light source having high energy is used, the polymerization reaction can proceed without using a polymerization initiator.

A reason for forming the porous precursor by the irradiation step will be described below for a case where the liquid composition causes polymerization-induced phase separation.

As described above, if a porous resin is formed by polymerization-induced phase separation, a structure, properties, and the like of the porous resin change based on the polymerization conditions.

For example, if a porous resin is formed under conditions in which a liquid composition is irradiated with active energy rays having high irradiation intensity to promote the polymerization of the polymerizable compound, the polymerization is proceeds before sufficient phase separation occurs, and thus, it is more difficult to manufacture a porous resin having high porosity.

Therefore, to form a porous resin having high porosity, the irradiation intensity of the active energy rays for irradiation is set not too high.

Specifically, the irradiation intensity of the active energy rays is preferably 1 W/cm2 or less, more preferably 300 mW/cm2 or less, and still more preferably 100 mW/cm2 or less. However, if the irradiation intensity of the active energy rays is too low, the phase separation proceeds excessively, which is likely to cause variations and coarsening of the porous structure, and also increases the irradiation time, resulting in reduced productivity. Accordingly, the irradiation intensity is preferably 10 mW/cm2 or more, and more preferably 30 mW/cm2 or more.

### <Removal Step>

The removal step is a step of removing a solvent or a dispersion liquid from the liquid composition.

A method of removing the solvent or the dispersion liquid is not particularly limited.

Examples of the method include, but are not limited to, a method of removing the solvent or the dispersion liquid from the porous resin by heating.

In this case, heating under reduced pressure is preferable because the removal of the solvent or the dispersion liquid can be further promoted and the solvent or the dispersion liquid can be prevented from remaining in the insulating layer to be formed.

### <Base Placement Step>

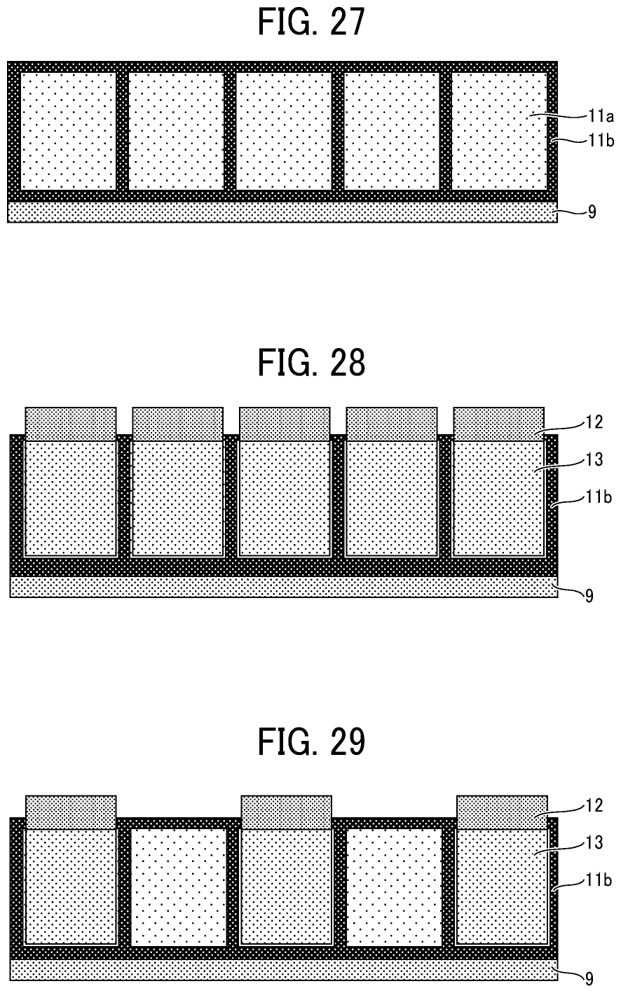

Abase placement step is a step of placing a second base, for example, as illustrated in FIG. 28, on a first base on which a functional film is formed as illustrated in FIG. 27, for example.

In FIGS. 27 and 28, reference numeral 9 denotes a current collector of a negative electrode which is an example of the first base, reference numeral 11a denotes a thin film region of an insulating layer which is an example of a functional film, reference numeral 11b denotes a thick film region of the insulating layer which is an example of the functional film, reference numeral 12 denotes a current collector of a positive electrode which is an example of the second base, and reference numeral 13 denotes an active material of the positive electrode, which is an example of the second base.

A method of placing the second base is not particularly limited, but if a placement region is not suitable, a short circuit may occur between the first base and the second base.

Therefore, the base placement step preferably includes an alignment step of adjusting a placement position of the second base after the insulating layer is formed on the first base.

In addition, to prevent misalignment after the second base is placed, an adhesive or a sticky material may be applied to the first base and/or the second base before the second base is placed.

### <Base Processing Step>

The base processing step is a step of processing, downstream of the functional film forming step, the first base on which the functional film is formed.

The base processing step may include at least one of a cutting step, a folding step, and a bonding step.

In the base processing step, for example, after the second base is placed, the first base can be cut to manufacture a base laminate in which the second base is placed on the first base on which the functional film is formed.

The base processing step preferably includes cutting the first base so that an area of the first base is larger than an area of the second base.

This makes it possible to prevent a cut end portion of the first base from being short-circuited with an end portion of the second base.

In a case where the insulating layer contains a material having a melting point or a glass transition temperature, the base processing step includes, for example, manufacturing a plurality of base laminates in which the second base is placed on the first base on which the insulating layer is formed, and at least partially bonding one base laminate and another base laminate by heating.

For example, in a case where the functional film forming step includes forming the insulating layer in a shape having an uneven pattern including a concave portion and a convex portion, that is, in a case where the base laminate includes the thick film region 11b of the insulating layer as illustrated in FIG. 26, thick film regions of base laminates positioned above and below each other may be heat-bonded.

In the base processing step, for example, the first base on which the second base is placed can be laminated or wound to manufacture a laminate or a wound body.

In the case where the first base on which the second base is placed is wound or laminated, the first base may be cut at an appropriate timing.

An example of a laminating method includes, but is not limited to, a method of cutting the first base on which the second base is placed into a plurality of sheets to manufacture a plurality of base laminates, and laminating the plurality of base laminates.

As illustrated in FIG. 29, another example of the laminating method includes, but is not limited to, a method of laminating the first base with second bases spaced apart thereon so that the first electrode is folded in a zigzag structure.

In FIG. 29, reference numeral 9 denotes a current collector of a negative electrode which is an example of the first base, reference numeral 11b denotes a thick film region of an insulating layer which is an example of a functional film, reference numeral 12 denotes a current collector of a positive electrode which is an example of the second base, and reference numeral 13 denotes an active material of the positive electrode, which is an example of the second base.

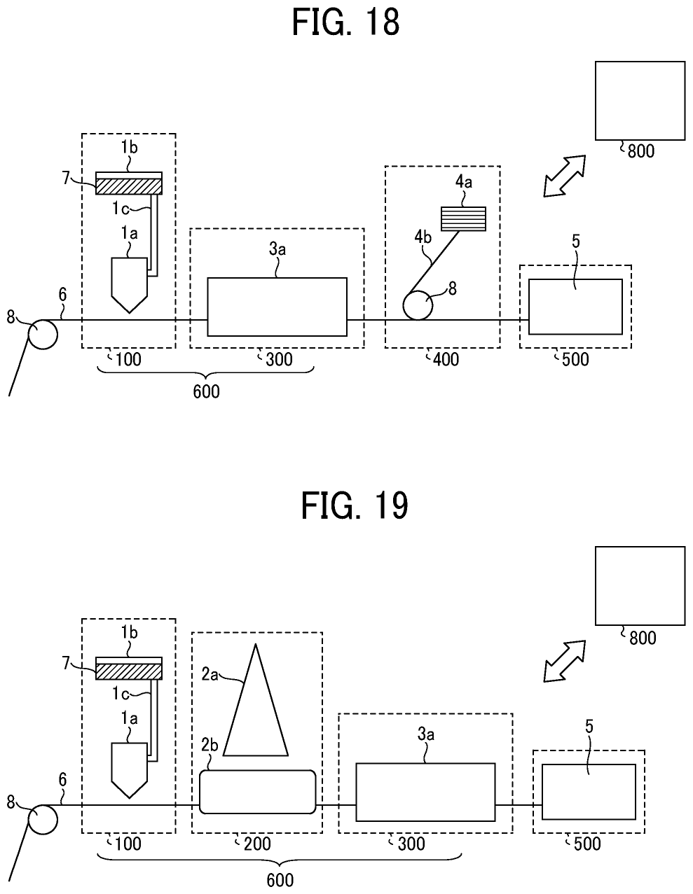

The winding can be performed, for example, by using an apparatus for manufacturing a member for a battery (described later) illustrated in FIG. 18.

That is, a second base having a roll shape can be supplied by a second base conveyance device 4b onto a first base 6 being conveyed, to continuously laminate the second base on the first base 6, and the resulting laminate can be wound by a base processing unit 500 positioned downstream of a base placement unit 400.

When the number of layers laminated in a zigzag structure or the number of turns wound in a winding structure reaches an intended number, an intended laminate or wound body can be obtained by cutting.

### <Conveyance Step>

The conveyance step is a step of conveying a first base to perform various types of steps with respect to the first base.

In the conveyance step, the first base can be conveyed at variable speed.

Thus, even in a case where a series of steps for manufacturing a member for a battery includes a placement step of placing a second base on a first base and a base processing step such as cutting or zigzag folding the first base, it is possible to improve the accuracy of the placement or the process.

Therefore, it is preferable that a conveyance speed in the conveyance step is varied, based on the processing timing in the base processing step.

That is, it is preferable to vary the speed according to an operation in the base processing step such as placement of the second base and cutting or zigzag folding of the first base.

A method of conveying the first base is not particularly limited. Examples of the method include, but are not limited to, a roll conveyance method and a belt conveyance method.

The term “roll conveyance” as used herein refers to a method of feeding while tension is applied between a conveyance start point and a conveyance end point, and if desired, a supporting member such as a guide roll may be used to support a member to be conveyed.

The roll conveyance includes, but is not limited to, conveyance by a roll-to-roll method.

The roll conveyance includes, for example, a case where a member to be conveyed is wound in a roll shape at the conveyance start point and the member to be conveyed is not wound in a roll shape at the conveyance end point.

In a speed change operation, for example, when a step including a process that hinders the conveyance of the first base, such as a step of cutting or folding the first base, is performed, it is preferable to decelerate the first base from a predetermined speed and convey the first substrate at a speed slower than the predetermined speed.

Such a speed change operation makes it possible to suppress damage to base end portions, even during cutting and folding steps.

Further, after the first base is decelerated and the step including the process that hinders the conveyance of the first base, such as a step of cutting or folding the first base, is performed, the first base is preferably accelerated to an original conveyance speed.

By performing such an operation, productivity can be improved.

### <<Apparatus for Manufacturing Member for Battery>>

An apparatus for manufacturing a member for a battery according to the present embodiment includes a conveyance unit that conveys a first base, a functional film forming unit that discharges a liquid composition onto the conveyed first base by a liquid discharge method to form a functional film, and a control unit that controls the conveyance unit. The control unit controls a conveyance speed of the conveyance unit to convey the first base at a variable speed.

The apparatus for manufacturing a member for a battery according to the present embodiment may include, if desired, an irradiation unit that irradiates the liquid composition with active energy rays, a removal unit that removes a solvent contained in the liquid composition, and a base processing unit that processes, after placement of a second base, the bases to form a cell.

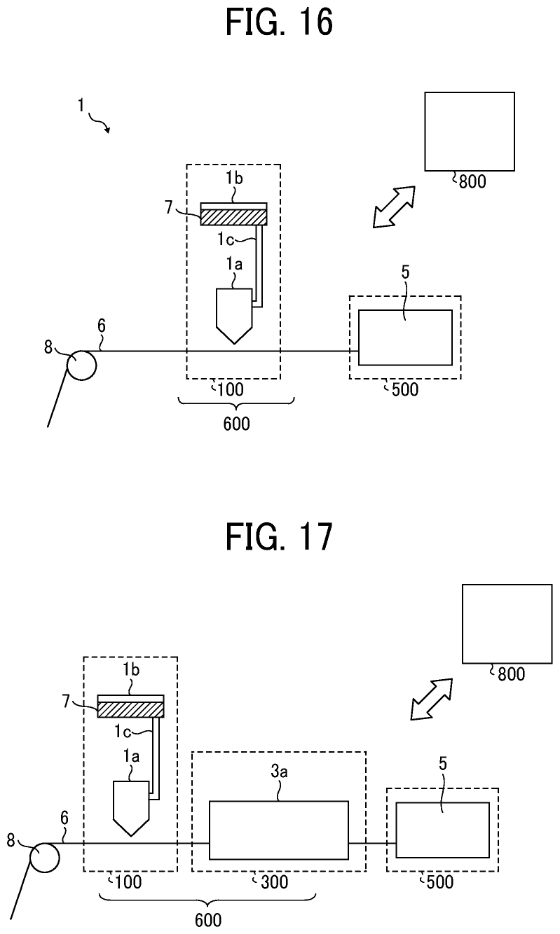

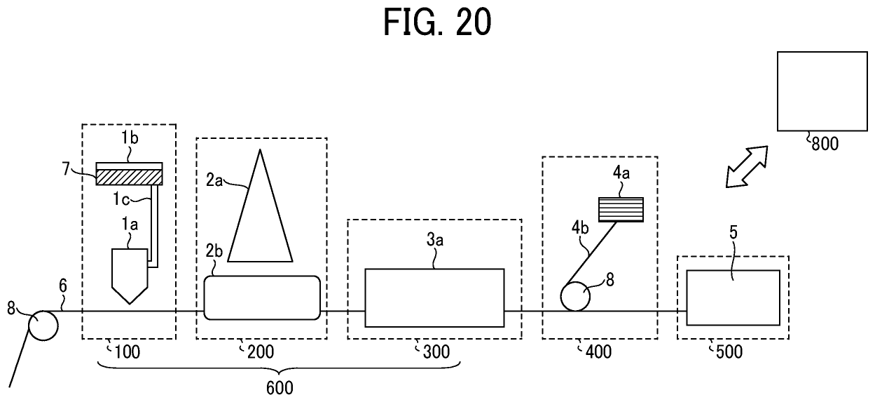

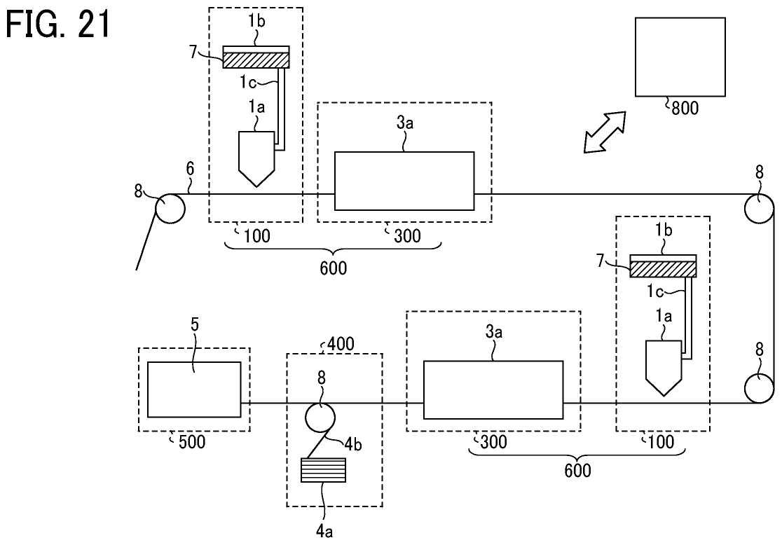

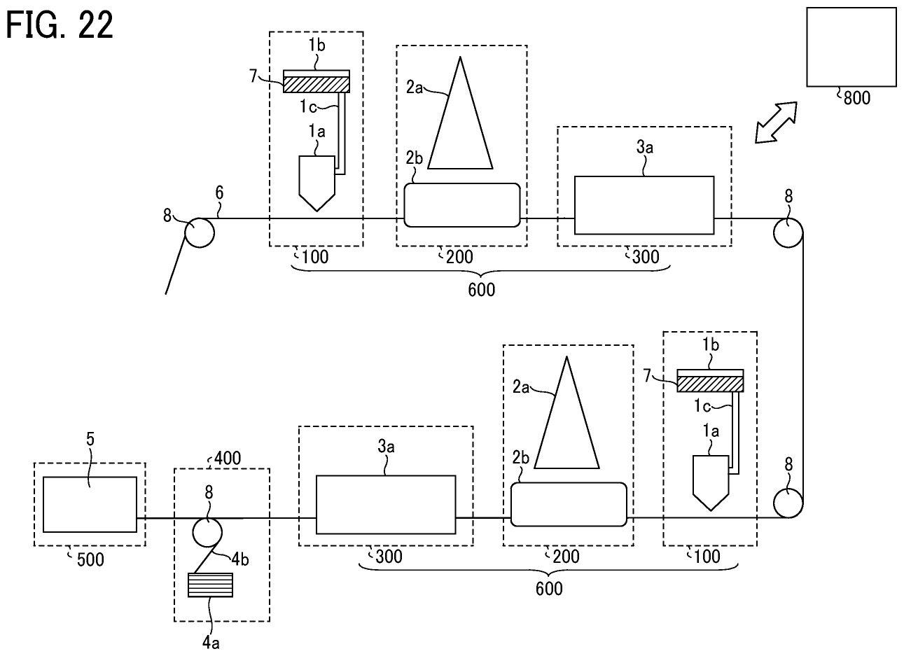

The apparatus for manufacturing a member for a battery will be described in detail with reference to FIGS. 16 to 25.

FIG. 16 is a schematic diagram illustrating an example of the apparatus for manufacturing a member for a battery.

A battery member manufacturing apparatus 1, which is an example of the apparatus for manufacturing a member for a battery, is an apparatus for manufacturing a member for a battery by using the above-described liquid composition.

The battery member manufacturing apparatus 1 includes a functional film forming unit 600 including the liquid application unit 100 that applies a liquid composition to form a functional film on a first base.

The battery member manufacturing apparatus 1 may include the base processing unit 500 and the like.

As illustrated in FIGS. 17 to 22 which are schematic diagrams illustrating examples of the apparatus for manufacturing a member for a battery, in addition to the steps described for the battery member manufacturing apparatus 1, there may be provided a group of processing units such as the irradiation unit 200 that performs a step of activating a polymerization initiator in the liquid composition to obtain an insulating layer by polymerization of a polymerizable compound, and the removal unit 300 that performs a step of heating the liquid composition to remove a solvent.

### <Functional Film Forming Unit>

The functional film forming unit 600 includes at least the liquid application unit 100 and may include the irradiation unit 200 and the removal unit 300, if desired.

### <Liquid Application Unit>

The liquid application unit 100 includes an inkjet device 1a that performs an application step of applying the liquid composition onto the first base, the storage container 1b that contains the liquid composition, and the supply tube 1c that supplies the liquid composition stored in the storage container 1b to the inkjet device 1a.

The storage container 1b contains the liquid composition 7. The liquid application unit 100 discharges the liquid composition 7 from the inkjet device 1a to apply the liquid composition 7 onto the first base 6 and form a liquid composition layer in a thin film shape.

The storage container 1b may be integrally formed with the battery member manufacturing apparatus 1, or may be detachable from the battery member manufacturing apparatus 1.

The storage container 1b may be a container used for addition to a storage container integrally formed with the battery member manufacturing apparatus 1 or a storage container detachable from the battery member manufacturing apparatus 1.

The storage container 1b and the supply tube 1c may have any configuration by which it is possible to stably store and supply the liquid composition 7.

A material forming the storage container 1b and the supply tube 1c preferably has a light-shielding property in a relatively short wavelength region of ultraviolet and visible light.

Thus, if the liquid composition 7 contains a polymerizable compound, the polymerizable compound is prevented from being polymerized by external light.

When the liquid application step is performed in the liquid application unit 100, it is preferable that a conveyance speed of the first base is relatively high, from the viewpoint of high productivity.

### <Group of Processing Units>

The group of processing units is a group including processing units that perform processes with respect to the first base conveyed by the conveyance unit, and include, for example, an irradiation unit, a removal unit, a base placement unit, and a base processing unit.

### <Irradiation Unit>

As illustrated in FIG. 19 for example, the irradiation unit 200 includes the light irradiation device 2a that irradiates the liquid composition with active energy rays such as heat and light to polymerize a polymerizable compound, and the inert polymerization gas circulating device 2b that circulates an inert polymerization gas.

If the liquid composition formed by the liquid application unit 100 contains a polymerizable compound, the light irradiation device 2a irradiates the liquid composition with light in the presence of an inert polymerization gas to form an insulating layer.

The light irradiation device 2a is not particularly limited and can be appropriately selected according to an absorption wavelength of a photopolymerization initiator contained in the liquid composition layer, as long as the light irradiation device 2a can initiate and promote the polymerization of compounds contained in the liquid composition layer. Examples of the light irradiation device 2a include, but are not limited to, ultraviolet light sources such as a high-pressure mercury lamp, a metal halide lamp, a hot cathode tube, a cold cathode tube, and an LED.

However, light having a shorter wavelength generally reaches a deeper portion more easily, and thus, the light source is preferably selected according to a thickness of the porous film to be formed.

The inert polymerization gas circulating device 2b lowers the concentration of polymerization-active oxygen in the atmosphere to promote a polymerization reaction of the polymerizable compound in the vicinity of a surface of the liquid composition layer without inhibition by oxygen.

The inert polymerization gas is not particularly limited, as long as the inert polymerization gas exerts the above-described function. Examples of the inert polymerization gas include, but are not limited to, nitrogen, carbon dioxide, and argon.

A flow rate of the inert polymerization gas is determined so that an inhibition reduction effect is efficiently obtained. The 02 concentration is preferably less than 20% (an environment where the oxygen concentration is lower than in the atmosphere), more preferably 0% or more and 15% or less, and still more preferably 0% or more and 5% or less.

The inert polymerization gas circulating device 2b preferably includes a temperature adjusting means that can adjust the temperature, to provide stable polymerization promoting conditions.

When the irradiation step is performed in the irradiation unit 200, the conveyance speed of the first base is preferably relatively low because in this case, it is possible to sufficiently promote the polymerization reaction.

### <Removal Unit>

As illustrated in FIG. 17 for example, the removal unit 300 includes the heating device 3a.

The heating device 3a heats and dries a solvent remaining in the formed functional film to remove the solvent.

The removal unit 300 may perform a solvent removing step under reduced pressure.

The removal unit 300 may heat and dry photopolymerization initiator remaining in the functional film by the heating device 3a to remove the photopolymerization initiator.

The heating device 3a is not particularly limited as long as the heating device 3a satisfies the above-described function. Examples of the heating device include, but are not limited to, an IR heater and a hot air heater.

It is possible to appropriately select a heating temperature and a heating time according to the boiling point of the solvent included in the functional film or the thickness of the formed film.

When the removal step is performed in the removal unit 300, the conveyance speed of the first base is preferably relatively low because in this case, it is possible to remove a sufficient amount of the solvent.

### <Base Placement Unit>

After the functional film is formed on the first base, the base placement unit 400 places a second base on the functional film.

As illustrated in FIG. 18 for example, the base placement unit 400 includes a second base container 4a, and uses the second base conveyance device 4b to place the second base onto the functional film formed on the first base.

The second base container 4a may be a wound base or a sheet base.

The second base conveyance device 4b is not particularly limited, as long as the second base conveyance device 4b can convey the base. An example of the second electrode conveyance device 4b includes, but is not limited to, a device that conveys the base by an attraction mechanism.

The base placement unit 400 may include, if desired, an alignment mechanism that adjusts a placement position of the second base by using a built-in camera or the like.

When a base placement step is performed in the base placement unit 400, it is preferable that a conveyance speed of the first base is relatively low, because in this case, it is possible to reduce damage to the first base due to the positioning accuracy in the placement and the friction during placement.

### <Base Processing Unit>

The base processing unit 500 processes, downstream of the functional film forming unit 600, the first base on which the functional film is formed.

The base processing unit 500 may perform at least one of cutting, folding, and bonding.

For example the base processing unit 500 can cut the first base after the placement of the second base to manufacture a base laminate.

The base processing unit 500 can wind or laminate the first base on which the second base is placed.

If the insulating layer contains a material having a melting point or a glass transition temperature, the base processing unit 500 at least partially bonds one base laminate and another base laminate by heating, for example.

As illustrated in FIGS. 16 to 22 for example, the base processing unit 500 includes a base processing device 5 to cut the base, zigzag fold, laminate, or wind the first base, thermally adhere the laminated or wound first bases, and the like, according to an intended battery form.

When the base processing unit 500 processes the base, it is preferable that the conveyance speed of the first base is relatively low, because in this case, it is possible to reduce damage to the processed base, such as wrinkles.

### <Conveyance Unit>

The conveyance unit conveys the first base so that the first base is subjected to various types of steps.

For example, if a method for conveying the first base is a roll conveyance method or a belt conveyance method, the conveyance unit is formed by the roll unit 8 illustrated in FIG. 16 and the like.

If the apparatus for manufacturing a member for a battery includes a plurality of the roll units 8, a part or all of the roll units 8 may be rotated under the control of the control unit 800, and may function as a conveyance unit that conveys the first base 6 at a predetermined speed.

Some of the roll units 8 may function as a guide roll that serves as a supporting member.

### <Control Unit>

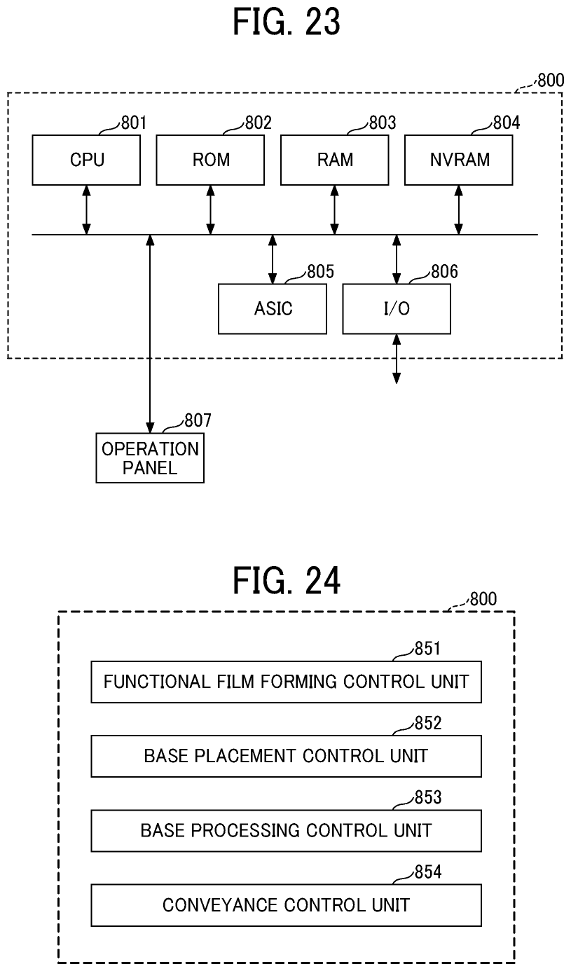

FIG. 23 is an example of a block diagram of main hardware of a control unit.

As illustrated in FIG. 23, the control unit 800 includes the CPU 801, the ROM 802, the RAM 803, the NVRAM 804, the ASIC 805, the I/O 806, and the operation panel 807, for example.

The CPU 801 generally controls the apparatus for manufacturing a member for a battery.

The ROM 802 stores a program executed by the CPU 801 and other fixed data.

The RAM 803 temporarily stores data and the like relating to a member for a battery.

The NVRAM 804 is a non-volatile memory for holding data while the apparatus is disconnected from a power source.

The ASIC 805 processes input/output signals for image processing and other control processes of the entire apparatus.

The I/O 806 is an interface for inputting/outputting signals to/from the functional film forming unit 600, the base placement unit 400, and the like.

The operation panel 807 receives an input of and displays information for the control unit 800.

FIG. 24 is an example of a diagram of main functional blocks of the control unit.

As illustrated in FIG. 24, the control unit 800 includes a functional film forming control unit 851, a base placement control unit 852, a base processing control unit 853, and a conveyance control unit 854 as functional blocks.

The functional film forming control unit 851 controls the functional film forming unit 600.

For example, the functional film forming control unit 851 issues an instruction to the liquid application unit 100 to control a timing and an amount of application of a liquid composition.

For example, if a functional film is formed by inkjet printing, the functional film forming control unit 851 issues an instruction to the liquid application unit 100 to apply the liquid composition at a predetermined timing, in a predetermined number of droplets, and under discharge conditions such as predetermined waveform data and a discharge frequency.

For example, the functional film forming control unit 851 issues an instruction to the irradiation unit 200 to control the timing, the irradiation amount, and the like when irradiating the liquid composition with active energy rays.

For example, the functional film forming control unit 851 issues an instruction to the removal unit 300 to control the timing, the heating amount, and the like when heating and drying the solvent to remove the solvent remaining in the functional layer.

For example, the base placement control unit 852 issues an instruction to the base placement unit 400 to control a timing for attracting the base, a speed of conveying the attracted base, and the like.

If the base placement unit 400 includes an alignment mechanism, the base placement control unit 852 controls the alignment mechanism to adjust a placement position of the second base, based on position information from an image sensor such as a camera.

For example, if the first base is cut by using a laser, the base processing control unit 853 issues an instruction to the base processing unit 500 to control an amount of emitted light of the laser and to scan the laser, based on position information from an image sensor such as a camera.

For example, the base processing control unit 853 issues an instruction to the base processing unit 500 to control a start timing, an end timing, and the like of zigzag folding, lamination, winding, and the like of the first base.

For example, the base processing control unit 853 issues an instruction to the base processing unit 500 to control the heating temperature and the heating time for thermally bonding the laminated or wound first bases.

The conveyance control unit 854 controls a conveyance speed of the conveyance unit.

For example, the conveyance control unit 854 may control the conveyance speed of the conveyance unit by varying the number of rotations of one of the roll units 8 or a plurality of the roll units 8.

The conveyance control unit 854 preferably changes the conveyance speed of the conveyance unit, based on a processing timing of the base processing unit 500.

For example, in a speed change operation of the conveyance unit controlled by the conveyance control unit 854, when a step including a process that hinders the conveyance of the first base, such as a step of cutting or zigzag folding the first base, is performed, it is preferable to perform control so that, during decelerating the first base and/or when the first base is decelerated, the first base is conveyed at a speed slower than a predetermined conveyance speed.

Such a speed change operation makes it possible to suppress damage to base end portions, even during cutting and zigzag folding steps.

Further, after the first base is decelerated and the step including the process that hinders the conveyance of the first base, such as a step of cutting or zigzag folding the first base, is performed, the conveyance control unit 854 preferably accelerates the first base to an original conveyance speed.

By performing such an operation, productivity can be improved.

The conveyance control unit 854 controls the liquid application unit to apply a liquid to the first base at a high speed when the conveyance speed is high, and controls the liquid application unit to apply the liquid to the first base at a low speed when the conveyance speed is low.

In addition, during acceleration/deceleration, the liquid application unit is controlled to apply the liquid under discharge conditions according to a change in the conveyance speed.

By performing such control, it is possible to manufacture with good productivity a base including a high-quality functional film having a constant thickness.

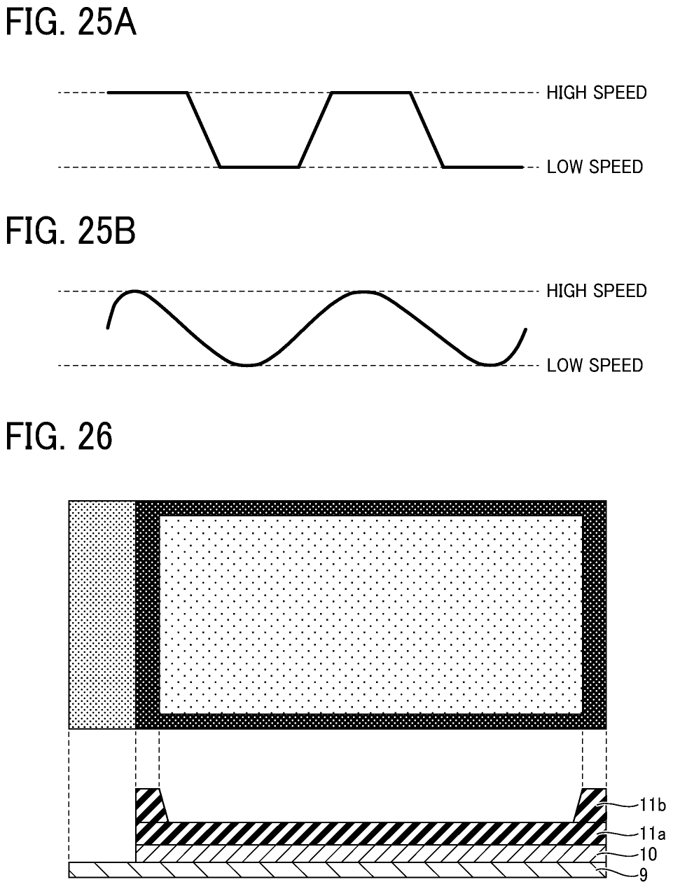

As illustrated in FIG. 25A for example, the conveyance control unit 854 can set a period during which the conveyance unit performs conveyance at high speed, a period during which the conveyance unit performs conveyance at low speed, and a transition period from low speed to high speed or from high speed to low speed.

The conveyance speed of the conveyance unit may be controlled in three or more stages.

Further, there may be a period during which conveyance is performed at a constant high speed or a constant low speed.

As illustrated in FIG. 25B, the conveyance speed of the conveyance unit may be controlled to have a curved shape, such as a sine curve, which does not include a constant speed region.

Note that the low speed includes a speed of zero.

The control unit 800 may control one or more processing units included in the group of processing units.

In this case, it is preferable that the control unit 800 jointly performs control of the conveyance speed of the conveyance unit and control of the plurality of processing units.

For example, when the conveyance speed is set to a low speed, the base processing unit 500 is caused to perform base processing such as cutting or zigzag folding of the first base, which is preferably performed at a relatively slow conveyance speed.

Such a control operation makes it possible to manufacture a high-quality base with excellent productivity.

It is preferable that the control unit 800 jointly controls the application conditions in the liquid application unit 100, the conveyance speed of the conveyance unit, and the plurality of processing units.

For example, the control unit 800 preferably changes a signal for discharging the liquid composition in synchronization with the speed change of the conveyance unit.

Specific examples of a cell and the like will be described below with reference to Examples and Comparative Examples, but the present embodiment is in no way limited to these Examples.

### EXAMPLES

First, a negative electrode and a positive electrode to be used in each Example and each Comparative Example were manufactured.

### <Manufacturing of Negative Electrode>

A negative electrode coating material for forming a negative electrode mixture layer was prepared by mixing 97.0 mass % of graphite, 1.0 mass % of a thickener (carboxymethyl cellulose), 2.0 mass % of polymer (styrene butadiene rubber), and 100.0 mass % of water as a solvent.

The negative electrode coating material was coated onto both surfaces of a copper foil base and then dried to obtain a negative electrode including a negative electrode mixture layer having a target weight of 9.0 mg/cm2 on each side.

Next, the obtained negative electrode was pressed using a roll press to obtain a volume density of 1.6 g/cm3 to obtain a negative electrode to be used.

At this time, the total film thickness of the negative electrode was 112.0 μm.

### <Manufacturing of Positive Electrode>

92.0 mass % of lithium nickel oxide (NCA) were prepared as a positive electrode active material, 3.0 mass % of acetylene black were prepared as a conductive material, and 5.0 mass % of polyvinylidene fluoride (PVDF) were prepared as a binder. Subsequently, these materials were dispersed in N-methylpyrrolidone (NMP) to prepare a positive electrode coating material.

The positive electrode coating material was coated onto both surfaces of an aluminum foil base and then dried to obtain a positive electrode including a positive electrode mixture layer having a target weight of 15.0 mg/cm2 on each side.

Next, the obtained positive electrode was pressed using a roll press to a volume density of 2.8 g/cm3 to obtain a positive electrode to be used.

At this time, the total film thickness of the positive electrode was 132.0 μm.

Finally, a die punching machine (punching area: 47.0 mm×27.0 mm) was used to punch out the positive electrode.

### Example 1

### —Adjustment of Insulating Layer Forming Liquid Composition—

Materials were mixed in the proportions described below to prepare an insulating layer forming liquid composition. 29.0 mass % of tricyclodecanedimethanol diacrylate (manufactured by Daicel-Allnex Ltd.) as a polymerizable compound (a resin A), 70.0 mass % of dipropylene glycol monomethyl ether (manufactured by Kanto Chemical Industry Co., Ltd.) as a solvent (porogen), and 1.0 mass % of IRGACURE 184 (manufactured by BASF) as a polymerization initiator were mixed to obtain an insulating layer forming liquid composition.

### <Formation of Insulating Layer and Cutting of First Base>

The manufacturing apparatus illustrated in FIG. 19 was used to form an insulating layer and cut a first base.

A negative electrode was prepared in a roll shape having a current collector width of 60 mm and a mixture layer width of 50 mm, and was conveyed while the conveyance speed was continuously changed between two speeds according to a cutting mechanism described below.
Non-cutting timing: 50 mm/sec
Cutting timing: 0 mm/sec

Simultaneously to the conveyance described above, the insulating layer forming liquid composition was filled into an inkjet printing device, and the discharge amount was controlled so that the amount of the liquid composition adhering to the variably conveyed negative electrode was constant, to form an insulating layer having a film thickness of 20.0 μm on both surfaces of the negative electrode mixture layer.

Immediately after that, in an N2 atmosphere, an application region of the insulating layer was irradiated with UV (light source: UV-LED (trade name: FJ800, manufactured by Phoseon Technology), wavelength: 365 nm, irradiation intensity: 30 mW/cm2, irradiation time: 20 s) to cure the insulating layer.

Next, the cured product was heated at 120° C. for 1 minute by using a hot air drying oven to remove the solvent.

Finally, in a base processing step to be performed after the removal step, the negative electrode was cut into a size of 60.0 mm long×30.0 mm wide, to obtain a negative electrode on which the insulating layer is formed.

### [Evaluation 1: Evaluation of Uniformity of Film Thickness]

The uniformity of the film thickness of the obtained negative electrode was evaluated by the following procedure.

Among a region where the negative electrode mixture layer is formed, a center region of 10.0 mm in a width direction is defined as a mixture layer center portion, and both end regions thereof are defined as mixture layer end portions. In the mixture layer center portion and the mixture layer end portions, the film thickness was measured at any three selected locations with a micrometer. The uniformity of the film thickness of the functional film was determined based on the magnitude of an average value for each location.

If the insulating layer includes a thin film region and a thick film region as in Example 2 and the like, the film thickness at any three selected locations in the thin film region was measured with a micrometer, and the uniformity of the film thickness of the functional film was determined from the magnitude of an average value for each location.

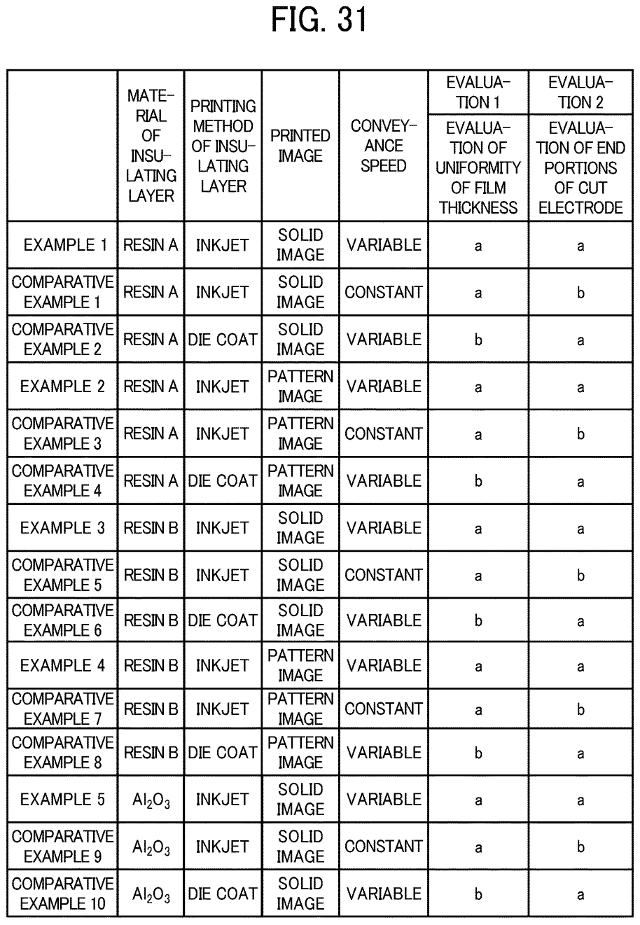

The results are presented in FIG. 31.

Note that “solid image” in the column for “printed image” in FIG. 31 indicates that the insulating layer was formed from the thin film region, and the thick film region was not formed.

Further, “pattern image” indicates that the thin film region and the thick film region were formed in the insulating layer.
a: Average value of film thickness in mixture layer end portions with respect to average value of film thickness in mixture layer center portion is less than 10%
b: Average value of film thickness in mixture layer end portions with respect to average value of film thickness in mixture layer center portion is 10% or more

### [Evaluation 2: Evaluation of End Portions of Cut Electrode]

To evaluate end portions of a cut electrode, the shape of a negative electrode cut into a size of 60.0 mm long×30.0 mm wide was measured.

The negative electrode is cut into a shape that is 30.0 mm wide. However, when wrinkles or twists occur at the end portions of the electrode due to contact between a cutting blade and the negative electrode moving in a conveyance direction during cutting, the width of the negative electrode may be shorter than 30.0 mm.

Therefore, by measuring the exact width of the cut negative electrode, the end portions of the cut electrode were evaluated according to the criteria mentioned below.

The results are presented in FIG. 31.
a: Difference between measured value of width of cut electrode and specified value is less than ±5%
a: Difference between measured value of width of cut electrode and specified value is ±5% or more

### Comparative Example 1

A first base having an insulating layer was obtained similarly to Example 1, except that a conveyance method of the negative electrode in Example 1 was changed to conveyance at a constant speed of 50.0 mm/sec.

Subsequently, Evaluations 1 and 2 were performed similarly to Example 1.

The results are presented in FIG. 31.

### Comparative Example 2

A first base having an insulating layer was obtained similarly to Example 1, except that, the method of forming the insulating layer in Example 1 was changed to a die coating method. Subsequently, Evaluations 1 and 2 were performed similarly to Example 1.

The results are presented in FIG. 31.

### Example 2

A first base having an insulating layer was obtained similarly to Example 1, except that, a formation region of the insulating layer in Example 1 was changed as described below. Subsequently, Evaluations 1 and 2 were performed similarly to Example 1.

The results are presented in FIG. 31.

### —Formation Region of Insulating Layer in Example 2—

The discharge amount of the liquid composition with respect to the negative electrode was controlled to form an insulating layer (a thin film region) and an insulating layer (a thick film region) on both surfaces of the negative electrode mixture layer so as to obtain a shape of a pattern image illustrated in FIG. 26.

The insulating layer (the thin film region) had an area of 47.0 mm×27.0 mm and a film thickness of 20.0 m, and the insulating layer (the thick film region) had a film thickness of 26.0 km.

### Comparative Example 3

A first base having an insulating layer was obtained similarly to Example 2, except that a conveyance method of the negative electrode in Example 2 was changed to conveyance at a constant speed of 50.0 mm/sec.

Subsequently, Evaluations 1 and 2 were performed similarly to Example 1.

The results are presented in FIG. 31.

### Comparative Example 4

A first base having an insulating layer was obtained similarly to Example 2, except that, the method of forming the insulating layer in Example 2 was changed to a die coating method. Subsequently, Evaluations 1 and 2 were performed similarly to Example 1.

The results are presented in FIG. 31.

### Example 3

A first base having an insulating layer was obtained similarly to Example 1, except that the formation of the insulating layer forming liquid composition was changed to a procedure described below.

Subsequently, Evaluations 1 and 2 were performed similarly to Example 1.

The results are presented in FIG. 31.

### —Formation of Insulating Layer Forming Liquid Composition in Example 3—

39.0 mass % of EBECRYL 8402 (manufactured by Daicel-Allnex Ltd.) as a polymerizable compound (a resin B), 60.0 mass % of diisobutyl ketone (manufactured by Kanto Chemical Industry Co., Ltd.) as porogen, and 1.0 mass % of IRGACURE 819 (manufactured by BASF) as a polymerization initiator were mixed to obtain an insulating layer forming liquid composition.

### Comparative Example 5

A first base having an insulating layer was obtained similarly to Example 3, except that a conveyance method of the negative electrode in Example 3 was changed to conveyance at a constant speed of 50.0 mm/sec.

Subsequently, Evaluations 1 and 2 were performed similarly to Example 1.

The results are presented in FIG. 31.

### Comparative Example 6

A first base having an insulating layer was obtained similarly to Example 3, except that, the method of forming the insulating layer in Example 3 was changed to a die coating method. Subsequently, Evaluations 1 and 2 were performed similarly to Example 1.

The results are presented in FIG. 31.

### Example 4

A first base having an insulating layer was obtained similarly to Example 3, except that, a formation region of the insulating layer in Example 3 was changed as described below. Subsequently, Evaluations 1 and 2 were performed similarly to Example 1.

The results are presented in FIG. 31.

### —Formation Region of Insulating Layer in Example 4—

The discharge amount of the liquid composition with respect to the negative electrode was controlled to form an insulating layer (a thin film region) and an insulating layer (a thick film region) on both surfaces of the negative electrode mixture layer so as to obtain a shape of a pattern image illustrated in FIG. 26.

The insulating layer (the thin film region) had an area of 47.0 mm×27.0 mm and a film thickness of 20.0 m, and the insulating layer (the thick film region) had a film thickness of 26.0 μm.

### Comparative Example 7

A first base having an insulating layer was obtained similarly to Example 4, except that a conveyance method of the negative electrode in Example 4 was changed to conveyance at a constant speed of 50.0 mm/sec.

Subsequently, Evaluations 1 and 2 were performed similarly to Example 1.

The results are presented in FIG. 31.

### Comparative Example 8

A first base having an insulating layer was obtained similarly to Example 4, except that, the method of forming the insulating layer in Example 4 was changed to a die coating method. Subsequently, Evaluations 1 and 2 were performed similarly to Example 1.

The results are presented in FIG. 31.

### Example 5

A first base having an insulating layer was obtained similarly to Example 1, except that the formation of the insulating layer forming liquid composition was changed to a procedure described below.

Subsequently, Evaluations 1 and 2 were performed similarly to Example 1.

The results are presented in FIG. 31.

### —Formation of Insulating Layer Forming Liquid Composition in Example 5—

A pre-dispersion liquid was prepared by mixing 40.0 mass % of α-alumina (having a primary particle diameter (D50) of 0.5 μm and a specific surface area of 7.8 g/m2) as an inorganic solid, 58.0 mass % of a mixed solution of dimethyl sulfoxide and ethylene glycol (DMSO-EG), and 2.0 mass % of MALIALIM HKM-150A (manufactured by NOF Corporation) as a dispersant.

The pre-dispersion liquid was filled in a container together with zirconia beads (Φ2 mm), and subjected to dispersion treatment at 1500 rpm for 3 minutes using a low temperature nano pulverizer NP-100 (manufactured by Thinky Corporation) to obtain a dispersion liquid.

A 25 μm mesh filter was used to remove the zirconia beads from the obtained dispersion liquid to prepare an insulating layer forming liquid composition.

### Comparative Example 9

A first base having an insulating layer was obtained similarly to Example 5, except that a conveyance method of the negative electrode in Example 5 was changed to conveyance at a constant speed of 50.0 mm/sec. Subsequently, Evaluations 1 and 2 were performed similarly to Example 1.

The results are presented in FIG. 31.

### Comparative Example 10

A first base having an insulating layer was obtained similarly to Example 5, except that, the method of forming the insulating layer in Example 5 was changed to a die coating method. Subsequently, Evaluations 1 and 2 were performed similarly to Example 1.

The results are presented in FIG. 31.

### —Manufacturing of Battery—

Lamination was performed in a state where the positive electrode faces the negative electrode obtained in the present Examples and Comparative Examples.

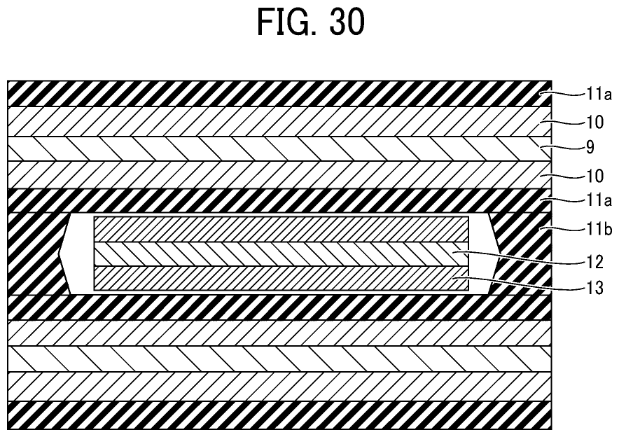

The obtained laminate was sealed using a laminate outer packaging material as an outer packaging to manufacture a storage element before injection of an electrolyte solution, as illustrated in FIG. 30.

The obtained element was vacuum-dried at 120° C. for 12 hours, and the electrolyte solution was injected into the element.

At that time, it was confirmed that, in Examples 3 and 4 and Comparative Examples 5, 6, 7, and 8, the thick film regions of first electrodes positioned above and below each other in the laminate were heat-bonded at electrode end portions.

A solution obtained by adding LiPF6, which is an electrolyte, to a mixture of ethylene carbonate (EC) and dimethyl carbonate (DMC) (a mixture having a mass ratio of “EC:DMC=1:1”) so that the concentration of LiPF6 is 1.5 mol/L, was used as the electrolyte solution.

From FIG. 31, it was found that, if the conveyance speed is variably changed in synchronization with an electrode cutting step, it is possible to improve the quality of the electrode end portions, and if an inkjet method is employed as the printing method, it is possible to suppress variations in the film thickness of the functional film to be formed and improve the uniformity of the film thickness.

This indicates that the effect is not dependent on the material, and the effect can be obtained by using an organic material or by using an inorganic material.

In a case where the resin B or the like having a low glass transition temperature (Tg) was used as the material for the insulating layer, it was also confirmed that thick film regions of first electrodes positioned above and below each other in the laminate at electrode end portions were heat-bonded by heating after the second electrode was placed and laminated, and thus, it was possible to obtain a laminate in which electrode misalignment is unlikely to occur after lamination.

Preferred embodiments have been described in detail above. However, the present embodiment is not limited to the above-described embodiments, and various modifications and substitutions can be made to the above-described embodiments without departing from the scope of the claims.

The above-described embodiments are illustrative and do not limit the present invention.

Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

This patent application is based on and claims priority to Japanese Patent Application Nos. 2022-043144 and 2022-043142, both filed on Mar. 17, 2022, in the Japan Patent Office, the entire disclosure of each of which is hereby incorporated by reference herein.

### REFERENCE SIGNS LIST

1a Printing device (inkjet device)
1b Storage container
1c Supply tube
2a Light irradiation device
2b Inert polymerization gas circulating device
3a Heating device
4a Second electrode container (second base container)
4b Second electrode conveyance device (second base conveyance device)
5 Electrode processing device (base processing device)
6 First electrode (first base)
7 Liquid composition
8 Roll unit
9 Current collector of first electrode (current collector of negative electrode)
10 Active material of first electrode (active material of negative electrode)
11a Thin film region of insulating layer
11b Thick film region of insulating layer
12 Current collector of second electrode (current collector of positive electrode)
13 Active material of second electrode (active material of positive electrode)
100 Liquid application unit
200 Irradiation unit
300 Removal unit
400 Electrode placement unit (base placement unit)
500 Electrode processing unit (base processing unit)
600 Insulating layer forming unit (functional film forming unit)
800 Control unit
801 CPU
802 ROM
803 RAM
804 NVRAM
805 ASIC
806 I/O
807 Operation panel
851 Insulating layer forming control unit (functional film forming control unit)
852 Electrode placement control unit (base placement control unit)
853 Electrode processing control unit (base processing control unit)
854 Conveyance control unit

1. A method of manufacturing a laminate for a battery, the method comprising:
forming an insulating layer on a first electrode; and
placing a second electrode on the first electrode formed with the insulating layer,
wherein:
the forming includes applying a liquid composition onto the first electrode, and
the forming and the placing are implemented by a conveyance series.

2. The method of manufacturing a laminate for a battery according to claim 1, further comprising:
processing, after the forming, the first electrode.

3. The method of manufacturing a laminate for a battery according to claim 2, wherein;
the insulating layer includes a material having a melting point or a glass transition temperature, and
the processing includes manufacturing a plurality of electrode laminates in which the second electrode is placed on the first electrode formed with the insulating layer, and at least partially bonding one electrode laminate of the plurality of electrode laminates and another electrode laminate of the plurality of electrode laminates by heat.

4. The method of manufacturing a laminate for a battery according to claim 2, wherein:
the processing includes cutting, before the second electrode is placed, the first electrode, and
the placing is performed immediately after the processing.

5. The method of manufacturing a laminate for a battery according to claim 1, wherein;
the first electrode includes a negative electrode, and
the second electrode includes a positive electrode.

6. The method of manufacturing a laminate for a battery according to claim 1, wherein:
the forming includes forming the insulating layer into a shape having an uneven pattern including a concave portion and a convex portion.

7. An apparatus for manufacturing a laminate for a battery, the apparatus comprising:
an insulating layer former to form an insulating layer on a first electrode; and
an electrode placer to place a second electrode on the first electrode formed with the insulating layer,
wherein:
the insulating layer former applies a liquid composition onto the first electrode, and
the insulating layer former and the electrode placer are in a conveyance series region where the first electrode is conveyed.

8. The apparatus for manufacturing a laminate for a battery according to claim 7, further comprising:
an electrode processor to process the first electrode formed with the insulating layer.

9. The apparatus for manufacturing a laminate for a battery according to claim 8, wherein;
the insulating layer includes a material having a melting point or a glass transition temperature, and
the electrode processor is to:
manufacture a plurality of electrode laminates in which the second electrode is placed on the first electrode formed with the insulating layer, and
heat one electrode laminate and another electrode laminate to at least partially bond the one electrode laminate and the other electrode laminate.

10. The apparatus for manufacturing a laminate for a battery according to claim 8, wherein;
the electrode processor to cut the first electrode before the second electrode is placed, and
the electrode placer is configured to place the second electrode on the first electrode that is cut.

11. The apparatus for manufacturing a laminate for a battery according to claim 7, wherein;
the first electrode includes a negative electrode, and
the second electrode includes a positive electrode.

12. The apparatus for manufacturing a laminate for a battery according to claim 7, wherein;
the insulating layer former is configured to form the insulating layer into a shape having an uneven pattern including a concave portion and a convex portion.

13. A method of manufacturing a member for a battery, comprising:
conveying a first base at a variable speed; and
forming a functional film by discharging a liquid composition onto the first base being conveyed.

14. The apparatus for according to claim 7, further comprising:
a conveyor to convey a first electrode; and
control circuitry configured to control the conveyor,
wherein the control circuitry controls a conveyance speed of the conveyor to convey the first base at a variable speed.
